(19) United States
(12) Patent Application Publication
(10) Pub. No.: US 2026/0267118 A1
(43) Pub. Date: Sep. 10, 2026

(54) OPTICAL SYSTEM, OPTICAL APPARATUS, AND METHOD FOR MANUFACTURING OPTICAL SYSTEM

(71) Applicant: Yoko KAMIYAMA, Yokohama-shi (JP)

(72) Inventor: Yoko KAMIYAMA, Yokohama-shi (JP)

(21) Appl. No.: 19/110,375

(22) PCT Filed: Jun. 8, 2023
(86) PCT No.: PCT/JP2023/021326

§ 371 Date: Mar. 10, 2025

(30) Foreign Application Priority Data
Sep. 14, 2022 (JP) 2022-145917

(51) Int. Cl. G02B 13/00

(52) U.S. Cl. CPC G02B 13/005

(57) ABSTRACT

An optical system that can obtain bright and favorable optical performance while achieving size reduction, an optical apparatus, and a method for manufacturing the optical system are provided. An optical system OL included in an optical apparatus such as a camera 1 includes, sequentially from an object side, a front group Gf having positive refractive power, an intermediate group Gi, and a rear group Gr having negative refractive power, the intermediate group Gi includes a first focusing group GF1 and a second focusing group GF2 that move along different loci, respectively, at focusing, the front group Gf includes, sequentially from the outermost object side, a negative lens component Ln1, a negative lens component Ln2, and a positive lens component Lp, a rear group G4 includes a negative lens component LnL closest to image plane side, and the optical system OL satisfies a condition expressed by predetermined conditional expressions.

### TECHNICAL FIELD

The present invention relates to an optical system, an optical apparatus, and a method for manufacturing the optical system.

### BACKGROUND ART

Conventionally, an optical system that is suitable for a still camera, an electronic still camera, a video camera, and the like has been disclosed (refer to Patent Literature 1, for example). For such an optical system, it is difficult to obtain bright and favorable optical performance while achieving size reduction.

### CITATION LIST

### Patent Literature

Patent Literature 1: Japanese Patent Laid-open No. 2017-211489

### SUMMARY OF INVENTION

An optical system according to a first aspect of the present invention includes, sequentially from an object side, a front group having positive refractive power, an intermediate group, and a rear group having negative refractive power, the intermediate group includes a first focusing group and a second focusing group that move along different loci, respectively, at focusing, the front group includes, sequentially from the outermost object side, a negative lens component, a negative lens component, and a positive lens component, the rear group includes a negative lens component closest to an image plane side, and the optical system satisfies a condition expressed by expressions below,

$$0.10 < \vert fF 1 \vert / ( - fr ) < 2.6$$

$$0.7 < \vert fF 2 \vert / ff < 2.$$

in the expressions,
fF1: focal length of the first focusing group,
fr: focal length of the rear group,
fF2: focal length of the second focusing group, and
ff: focal length of the front group.

An optical system according to a second aspect of the present invention includes, sequentially from an object side, a front group having positive refractive power, an intermediate group, and a rear group having negative refractive power, the intermediate group includes a first focusing group and a second focusing group that move along different loci, respectively, at focusing, the front group includes, sequentially from the outermost object side, a negative lens component, a negative lens component, and a positive lens component, the rear group includes a negative lens component closest to an image plane side, and the optical system satisfies a condition expressed by expressions below,

$$0. 5 < ff / ( - fr ) < 0 \text{.90}$$

$$- 1. < ( r 2 + r 1 ) / ( r 2 - r 1 ) < 0.2$$

in the expressions,
ff: focal length of the front group,
fr: focal length of the rear group,
r1: radius of curvature of a lens surface of a lens component disposed closest to the object side, the lens surface being on the image plane side, and
r2: radius of curvature of a lens surface of a lens component disposed second closest to the object side, the lens surface being on the object side.

A method for manufacturing the optical system according to the first aspect of the present invention is a method for manufacturing an optical system including, sequentially from an object side, a front group having positive refractive power, an intermediate group, and a rear group having negative refractive power, the method including: disposing the intermediate group to include a first focusing group and a second focusing group that move along different loci, respectively, at focusing; disposing the front group to include sequentially from the outermost object side, a negative lens component, a negative lens component, and a positive lens component; disposing the rear group to include a negative lens component closest to image plane side; and disposing the lens groups so that a condition expressed by expressions below is satisfied,

$$0.10 < \vert fF 1 \vert / ( - fr ) < 2.6$$

$$0.7 < \vert fF 2 \vert / ff < 2.$$

in the expressions,
fF1: focal length of the first focusing group,
fr: focal length of the rear group,
fF2: focal length of the second focusing group, and
ff: focal length of the front group.

A method for manufacturing the optical system according to the second aspect of the present invention is a method for manufacturing an optical system including, sequentially from an object side, a front group having positive refractive power, an intermediate group, and a rear group having negative refractive power, the method including: disposing the intermediate group to include a first focusing group and a second focusing group that move along different loci, respectively, at focusing; disposing the front group to include, sequentially from the outermost object side, a negative lens component, a negative lens component, and a positive lens component; disposing the rear group to include a negative lens component closest to image plane side; and disposing the lens groups so that a condition expressed by expressions below is satisfied,

$$0.05 < ff / ( - fr ) < 0 \text{.90}$$

$$- 1. < ( r 2 + r 1 ) / ( r 2 - r 1 ) < 0.2$$

in the expressions,
ff: focal length of the front group,
fr: focal length of the rear group,
r1: radius of curvature of a lens surface of a lens component disposed closest to the object side, the lens surface being on the image plane side, and
r2: radius of curvature of a lens surface of a lens component disposed second closest to the object side, the lens surface being on the object side.

### BRIEF DESCRIPTION OF DRAWINGS

FIG. 1 is a cross-sectional view showing a lens configuration of an optical system according to a first example at focusing on an infinite distance object.

FIG. 2 shows a variety of aberration diagrams of the optical system according to the first example; (a) shows focusing on an infinite distance object and (b) shows focusing on a close distance object.

FIG. 3 is a cross-sectional view showing a lens configuration of optical system according to a second example at focusing on an infinite distance object.

FIG. 4 shows a variety of aberration diagrams of the optical system according to the second example; (a) shows focusing on an infinite distance object and (b) shows focusing on a close distance object.

FIG. 5 is a cross-sectional view showing a lens configuration of an optical system according to a third example at focusing on an infinite distance object.

FIG. 6 shows a variety of aberration diagrams of the optical system according to the third example; (a) shows focusing on an infinite distance object and (b) shows focusing on a close distance object.

FIG. 7 is a cross-sectional view showing a lens configuration of an optical system according to a fourth example at focusing on an infinite distance object.

FIG. 8 shows a variety of aberration diagrams of the optical system according to the fourth example; (a) shows focusing on an infinite distance object and (b) shows focusing on a close distance object.

FIG. 9 is a cross-sectional view showing a lens configuration of an optical system according to a fifth example at focusing on an infinite distance object.

FIG. 10 shows a variety of aberration diagrams of the optical system according to the fifth example; (a) shows focusing on an infinite distance object and (b) shows focusing on a close distance object.

FIG. 11 is a cross-sectional view showing a lens configuration of an optical system according to a sixth example at focusing on an infinite distance object.

FIG. 12 shows a variety of aberration diagrams of the optical system according to the sixth example; (a) shows focusing on an infinite distance object and (b) shows focusing on a close distance object.

FIG. 13 is a cross-sectional view showing a lens configuration of an optical system according to a seventh example at focusing on an infinite distance object.

FIG. 14 shows a variety of aberration diagrams of the optical system according to the seventh example; (a) shows focusing on an infinite distance object and (b) shows focusing on a close distance object.

FIG. 15 is a cross-sectional view showing a lens configuration of an optical system according to an eighth example at focusing on an infinite distance object.

FIG. 16 shows a variety of aberration diagrams of the optical system according to the eighth example; (a) shows focusing on an infinite distance object and (b) shows focusing on a close distance object.

FIG. 17 is a cross-sectional view showing a lens configuration of an optical system according to a ninth example at focusing on an infinite distance object.

FIG. 18 shows a variety of aberration diagrams of the optical system according to the ninth example; (a) shows focusing on an infinite distance object and (b) shows focusing on a close distance object.

FIG. 19 is a cross-sectional view showing a lens configuration of an optical system according to a tenth example at focusing on an infinite distance object.

FIG. 20 shows a variety of aberration diagrams of the optical system according to the tenth example; (a) shows focusing on an infinite distance object and (b) shows focusing on a close distance object.

FIG. 21 is a cross-sectional view showing a lens configuration of an optical system according to an eleventh example at focusing on an infinite distance object.

FIG. 22 shows a variety of aberration diagrams of the optical system according to the eleventh example; (a) shows focusing on an infinite distance object and (b) shows focusing on a close distance object.

FIG. 23 is a cross-sectional view of a camera on which an above-described optical system is mounted.

FIG. 24 is a flowchart for description of a method for manufacturing the above-described optical system.

### DESCRIPTION OF EMBODIMENTS

Preferable embodiments will be described below with reference to the accompanying drawings.

### First Embodiment

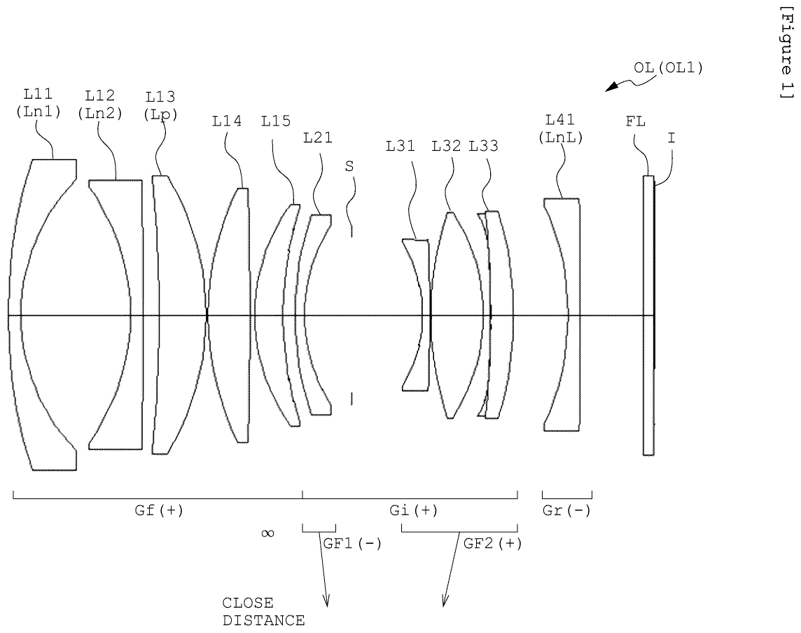

As shown in FIG. 1, an optical system OL according to a first embodiment includes, sequentially from an object side, a front group Gf having positive refractive power, an intermediate group Gi, and a rear group Gr having negative refractive power. The intermediate group Gi includes a first focusing group GF1 and a second focusing group GF2 that move along different loci, respectively, at focusing. The front group Gf includes, sequentially from the outermost object side, a negative lens component Ln1, a negative lens component Ln2, and a positive lens component Lp, and the rear group Gr includes a negative lens component LnL closest to an image plane side. With this configuration, the optical system OL can obtain bright and favorable optical performance at image capturing from an infinite distance object to a close distance object while achieving size reduction.

The optical system OL according to the first embodiment preferably satisfies Conditional Expression (1) shown below.

$$0.10 < \vert fF 1 \vert / ( - fr ) < 2.6 \qquad ( 1 )$$

in the expression,
fF1: focal length of the first focusing group GF1, and
fr: focal length of the rear group Gr.

Conditional Expression (1) defines the ratio of the focal length of the first focusing group GF1 to the focal length of the rear group Gr. By satisfying Conditional Expression (1), it is possible to excellently correct a variety of aberrations such as coma aberration at image capturing from an infinite distance object to a close distance object. When the upper limit value of Conditional Expression (1) is exceeded, that is, the focal length of the rear group Gr is too short, it is difficult to correct coma aberration and field curvature and impossible to obtain favorable optical performance, and thus such a configuration is not preferable. Meanwhile, it is possible to secure the advantageous effect of the present embodiment more surely by setting the upper limit value of Conditional Expression (1) to 2.50. Further, in order to secure the advantageous effect of the present embodiment further more surely, it is preferable to set the upper limit value of Conditional Expression (1) to 2.00, 1.75, 1.60, and more preferable to 1.50. Moreover, when the lower limit value of Conditional Expression (1) is exceeded, that is, the focal length of the first focusing group GF1 is too short, it is difficult to correct spherical aberration and coma aberration at focusing on a close distance object and impossible to obtain favorable optical performance, and thus such a configuration is not preferable. Meanwhile, it is possible to secure the advantageous effect of the present embodiment more surely by setting the lower limit value of Conditional Expression (1) to 0.25. Further, in order to secure the advantageous effect of the present embodiment further more surely, it is preferable to set the lower limit value of Conditional Expression (1) to 0.40, 0.50, 0.60, 0.75, and more preferable to 0.80.

The optical system OL according to the first embodiment preferably satisfies Conditional Expression (2) shown below.

$$0.7 < \vert fF 2 \vert / ff < 2 \text{.00} \qquad ( 2 )$$

in the expression,
fF2: focal length of the second focusing group GF2, and
ff: focal length of the front group Gf.

Conditional Expression (2) defines the ratio of the focal length of the second focusing group GF2 to the focal length of the front group Gf. By satisfying Conditional Expression (2), it is possible to excellently correct a variety of aberrations such as coma aberration at image capturing from an infinite distance object to a close distance object. When the upper limit value of Conditional Expression (2) is exceeded, that is, the focal length of the front group Gf is too short, it is difficult to correct spherical aberration, coma aberration, and field curvature and impossible to obtain favorable optical performance, and thus such a configuration is not preferable. Meanwhile, it is possible to secure the advantageous effect of the present embodiment more surely by setting the upper limit value of Conditional Expression (2) to 1.85. Further, in order to secure the advantageous effect of the present embodiment further more surely, it is preferable to set the upper limit value of Conditional Expression (2) to 1.75, 1.60, and more preferable to 1.50. Moreover, when the lower limit value of Conditional Expression (2) is exceeded, that is, the focal length of the second focusing group GF2 is too short, it is difficult to correct coma aberration and field curvature at focusing on a close distance object and impossible to obtain favorable optical performance, and thus such a configuration is not preferable. Meanwhile, it is possible to secure the advantageous effect of the present embodiment more surely by setting the lower limit value of Conditional Expression (2) to 0.85. Further, in order to secure the advantageous effect of the present embodiment further more surely, it is preferable to set the lower limit value of Conditional Expression (2) to 0.95, 1.00, and more preferable to 1.10.

### Second Embodiment

As shown in FIG. 1, an optical system OL according to a second embodiment includes, sequentially from an object side, a front group Gf having positive refractive power, an intermediate group Gi, and a rear group Gr having negative refractive power. The intermediate group Gi includes a first focusing group GF1 and a second focusing group GF2 that move along different loci, respectively, at focusing. The front group Gf includes, sequentially from the outermost object side, a negative lens component Ln1, a negative lens component Ln2, and a positive lens component Lp, and the rear group Gr includes a negative lens component LnL closest to an image plane side. With this configuration, the optical system OL can obtain bright and favorable optical performance at image capturing from an infinite distance object to a close distance object while achieving size reduction.

The optical system OL according to the second embodiment preferably satisfies Conditional Expression (3) shown below.

$$0. 5 < ff / ( - fr ) < 0 \text{.90} \qquad ( 3 )$$

in the expression,
ff: focal length of the front group Gf, and
fr: focal length of the rear group Gr.

Conditional Expression (3) defines the ratio of the focal length of the front group Gf to the focal length of the rear group Gr. By satisfying Conditional Expression (3), it is possible to excellently correct a variety of aberrations such as coma aberration and field curvature. When the upper limit value of Conditional Expression (3) is exceeded, that is, the focal length of the rear group Gr is too short, it is difficult to correct coma aberration and field curvature and impossible to obtain favorable optical performance, and thus such a configuration is not preferable. Meanwhile, it is possible to secure the advantageous effect of the present embodiment more surely by setting the upper limit value of Conditional Expression (3) to 0.80. Further, in order to secure the advantageous effect of the present embodiment further more surely, it is preferable to set the upper limit value of Conditional Expression (3) to 0.75, 0.65, and more preferable to 0.60. Moreover, when the lower limit value of Conditional Expression (3) is exceeded, that is, the focal length of the front group Gf is too short, it is difficult to correct spherical aberration, coma aberration, and field curvature and impossible to obtain favorable optical performance, and thus such a configuration is not preferable. Meanwhile, it is possible to secure the advantageous effect of the present embodiment more surely by setting the lower limit value of Conditional Expression (3) to 0.10. Further, in order to secure the advantageous effect of the present embodiment further more surely, it is preferable to set the lower limit value of Conditional Expression (3) to 0.25, 0.50, 0.75, 0.85, 1.00, and more preferable to 1.10.

The optical system OL according to the second embodiment preferably satisfies Conditional Expression (4) shown below.

$$- 1.0 \; 00 < ( r 2 + r 1 ) / ( r 2 - r 1 ) < 0.2 \qquad ( 4 )$$

in the expression,
r1: radius of curvature of a lens surface of the lens component Ln1 disposed closest to the object side, the lens surface being on the image plane side, and
r2: radius of curvature of a lens surface of the lens component Ln2 disposed second closest to the object side, the lens surface being on the object side.

Conditional Expression (4) defines the shape factor of the image-plane-side lens surface of the lens component Ln1 disposed closest to the object side to the object-side lens surface of the lens component Ln2 disposed second closest to the object side. By satisfying Conditional Expression (4), it is possible to excellently correct a variety of aberrations such as spherical aberration, coma aberration, and field curvature. When the upper limit value of Conditional Expression (4) is exceeded, it is difficult to correct spherical aberration, coma aberration, and field curvature and impossible to obtain favorable optical performance, and thus such a configuration is not preferable. Meanwhile, it is possible to secure the advantageous effect of the present embodiment more surely by setting the upper limit value of Conditional Expression (4) to 0.180. Further, in order to secure the advantageous effect of the present embodiment further more surely, it is preferable to set the upper limit value of Conditional Expression (4) to 0.150, 0.100, 0.095, and more preferable to 0.090. Moreover, when the lower limit value of Conditional Expression (4) is exceeded, it is difficult to correct spherical aberration, coma aberration, and field curvature and impossible to obtain favorable optical performance, and thus such a configuration is not preferable. Meanwhile, it is possible to secure the advantageous effect of the present embodiment more surely by setting the lower limit value of Conditional Expression (4) to −0.900. Further, in order to secure the advantageous effect of the present embodiment further more surely, it is preferable to set the lower limit value of Conditional Expression (4) to −0.750, −0.500, −0.350, and more preferable to −0.250.

### First and Second Embodiments

The optical system OL according to the first embodiment preferably satisfies Conditional Expressions (3) and (4) described above. The advantageous effect and the like obtained by satisfying Conditional Expressions (3) and (4) are as described above.

The optical system OL according to the first and second embodiment (hereinafter referred to as “the present embodiment”) preferably satisfies Conditional Expression (5) shown below.

$$0.10 < \vert fF 2 \vert / \vert fF 1 \vert < 1.1 \qquad ( 5 )$$

in the expression,
fF1: focal length of the first focusing group GF1, and
fF2: focal length of the second focusing group GF2.

Conditional Expression (5) defines the ratio of the focal length of the second focusing group GF2 to the focal length of the first focusing group GF1. By satisfying Conditional Expression (5), it is possible to excellently correct a variety of aberrations such as spherical aberration, coma aberration, and field curvature at image capturing from an infinite distance object to a close distance object. In addition, the optical system OL can obtain bright and favorable optical performance at image capturing from an infinite distance object to a close distance object while achieving size reduction. When the upper limit value of Conditional Expression (5) is exceeded, that is, the focal length of the first focusing group GF1 is too short, it is impossible to obtain favorable optical performance at focusing on a close distance object because of large spherical aberration, coma aberration, and field curvature that occur at the first focusing group GF1, and thus such a configuration is not preferable. Meanwhile, it is possible to secure the advantageous effect of the present embodiment more surely by setting the upper limit value of Conditional Expression (5) to 1.05. Further, in order to secure the advantageous effect of the present embodiment further more surely, it is preferable to set the upper limit value of Conditional Expression (5) to 1.00, 0.90, 0.85, 0.80, 0.75, 0.70, and more preferable to 0.65. Moreover, when the lower limit value of Conditional Expression (5) is exceeded, that is, the focal length of the second focusing group GF2 is too short, it is impossible to obtain favorable optical performance at focusing on a close distance object because of large spherical aberration, coma aberration, and field curvature that occur at the second focusing group GF2, and thus such a configuration is not preferable. Meanwhile, it is possible to secure the advantageous effect of the present embodiment more surely by setting the lower limit value of Conditional Expression (5) to 0.15. Further, in order to secure the advantageous effect of the present embodiment further more surely, it is preferable to set the lower limit value of Conditional Expression (5) to 0.20, and more preferable to 0.25.

The optical system OL according to the present embodiment preferably satisfies Conditional Expression (6) shown below.

$$0.1 < ff / \vert fF 1 \vert < 0.65 \qquad ( 6 )$$

in the expression,
ff: focal length of the front group Gf, and
fF1: focal length of the first focusing group GF1.

Conditional Expression (6) defines the ratio of the focal length of the front group Gf to the focal length of the first focusing group GF1. By satisfying Conditional Expression (6), it is possible to excellently correct a variety of aberrations such as spherical aberration, coma aberration, and field curvature at image capturing from an infinite distance object to a close distance object. Moreover, the optical system OL can obtain bright and favorable optical performance at image capturing from an infinite distance object to a close distance object while achieving size reduction. When the upper limit value of Conditional Expression (6) is exceeded, that is, the focal length of the first focusing group GF1 is too short, it is impossible to obtain favorable optical performance at focusing on a close distance object because of large spherical aberration, coma aberration, and field curvature that occur at the first focusing group GF1, and thus such a configuration is not preferable. Meanwhile, it is possible to secure the advantageous effect of the present embodiment more surely by setting the upper limit value of Conditional Expression (6) to 0.60. Further, in order to secure the advantageous effect of the present embodiment further more surely, it is preferable to set the upper limit value of Conditional Expression (6) to 0.55, 0.50, 0.45, and more preferable to 0.42. Moreover, when the lower limit value of Conditional Expression (6) is exceeded, that is, the focal length of the front group Gf is too short, it is impossible to obtain favorable optical performance at focusing on a close distance object because of large spherical aberration, coma aberration, and field curvature that occur at the front group Gf, and thus such a configuration is not preferable. Meanwhile, it is possible to secure the advantageous effect of the present embodiment more surely by setting the lower limit value of Conditional Expression (6) to 0.15. Further, in order to secure the advantageous effect of the present embodiment further more surely, it is preferable to set the lower limit value of Conditional Expression (6) to 0.18, and more preferable to 0.20.

The optical system OL according to the present embodiment preferably satisfies Conditional Expression (7) shown below.

$$1. 10 < ( - fr ) / \vert fF 2 \vert < 2.4 \qquad ( 7 )$$

in the expression,
fr: focal length of the rear group Gr, and
fF2: focal length of the second focusing group GF2.

Conditional Expression (7) defines the ratio of the focal length of the rear group Gr to the focal length of the second focusing group GF2. By satisfying Conditional Expression (7), it is possible to excellently correct a variety of aberrations such as spherical aberration, coma aberration, and field curvature. Moreover, the optical system OL can obtain bright and favorable optical performance at image capturing from an infinite distance object to a close distance object while achieving size reduction. When the upper limit value of Conditional Expression (7) is exceeded, that is, the focal length of the second focusing group GF2 is too short, it is impossible to obtain favorable optical performance at focusing on a close distance object because of large spherical aberration, coma aberration, and field curvature that occur at the second focusing group GF2, and thus such a configuration is not preferable. Meanwhile, it is possible to secure the advantageous effect of the present embodiment more surely by setting the upper limit value of Conditional Expression (7) to 2.35. Further, in order to secure the advantageous effect of the present embodiment further more surely, it is preferable to set the upper limit value of Conditional Expression (7) to 2.25, and more preferable to 2.21. Moreover, when the lower limit value of Conditional Expression (7) is exceeded, that is, the focal length of the rear group Gr is too short, it is impossible to obtain favorable optical performance at focusing on a close distance object because of large spherical aberration, coma aberration, and field curvature that occur at the rear group Gr, and thus such a configuration is not preferable. Meanwhile, it is possible to secure the advantageous effect of the present embodiment more surely by setting the lower limit value of Conditional Expression (7) to 1.15. Further, in order to secure the advantageous effect of the present embodiment further more surely, it is preferable to set the lower limit value of Conditional Expression (7) to 1.25, 1.30, 1.40, and more preferable to 1.50.

The optical system OL according to the present embodiment preferably includes an aperture (aperture stop S) between the first focusing lens group GF1 and the second focusing lens group GF2 and satisfies Conditional Expression (8) shown below.

$$1. < fsr / fsf < 2 \text{.20} \qquad ( 8 )$$

in the expression,
fsr: combined focal length of lenses disposed on the image plane side of the aperture (aperture stop S) at focusing on an infinite distance object, and
fsf: combined focal length of lenses disposed on the object side of the aperture (aperture stop S) at focusing on an infinite distance object.

Conditional Expression (8) defines the ratio of the combined focal length of lenses disposed on the image plane side of the aperture to the combined focal length of lenses disposed on the object side of the aperture at focusing on an infinite distance object. By satisfying Conditional Expression (8), it is possible to excellently correct a variety of aberrations such as coma aberration and field curvature. Moreover, the optical system OL can obtain bright and favorable optical performance while achieving size reduction. When the upper limit value of Conditional Expression (8) is exceeded, that is, the combined focal length of lenses disposed on the object side of the aperture is too short, it is difficult to correct spherical aberration, coma aberration, and field curvature and impossible to obtain favorable optical performance, and thus such a configuration is not preferable. Meanwhile, it is possible to secure the advantageous effect of the present embodiment more surely by setting the upper limit value of Conditional Expression (8) to 2.15. Further, in order to secure the advantageous effect of the present embodiment further more surely, it is preferable to set the upper limit value of Conditional Expression (8) to 2.10, and more preferable to 2.05. Moreover, when the lower limit value of Conditional Expression (8) is exceeded, that is, the combined focal length of lenses disposed on the image plane side of the aperture is too short, it is difficult to correct coma aberration and field curvature and impossible to obtain favorable optical performance, and thus such a configuration is not preferable. Meanwhile, it is possible to secure the advantageous effect of the present embodiment more surely by setting the lower limit value of Conditional Expression (8) to 1.05. Further, in order to secure the advantageous effect of the present embodiment further more surely, it is preferable to set the lower limit value of Conditional Expression (8) to 1.10, 1.15, and more preferable to 1.20.

The optical system OL according to the present embodiment preferably satisfies Conditional Expression (9) shown below.

$$0.8 < y / Bfa < 2 \text{.10} \qquad ( 9 )$$

in the expression,
y: image height of the optical system OL, and
Bfa: back focus (air-conversion length) of the optical system OL at focusing on an infinite distance object.

Conditional Expression (9) defines the ratio of the image height of the optical system OL to the back focus (air-conversion length) thereof at focusing on an infinite distance object. By satisfying Conditional Expression (9), the optical system OL can obtain bright and favorable optical performance while achieving size reduction. Meanwhile, it is possible to secure the advantageous effect of the present embodiment more surely by setting the upper limit value of Conditional Expression (9) to 2.08, and more preferable to 2.05. Moreover, it is possible to secure the advantageous effect of the present embodiment more surely by setting the lower limit value of Conditional Expression (9) to 1.00. Further, in order to secure the advantageous effect of the present embodiment further more surely, it is preferable to set the lower limit value of Conditional Expression (9) to 1.25, 1.35, 1.50, and more preferable to 1.75.

The optical system OL according to the present embodiment preferably satisfies Conditional Expression (10) shown below.

$$1.5 < f / Bfa < 5. \qquad ( 10 )$$

in the expression,
f: overall focal length of the optical system OL at focusing on an infinite distance object, and
Bfa: back focus (air-conversion length) of the optical system OL at focusing on an infinite distance object.

Conditional Expression (10) defines the ratio of the overall focal length of the optical system OL to the back focus (air-conversion length) thereof at focusing on an infinite distance object. By satisfying Conditional Expression (10), the optical system OL can obtain bright and favorable optical performance while achieving size reduction. Meanwhile, it is possible to secure the advantageous effect of the present embodiment more surely by setting the upper limit value of Conditional Expression (10) to 4.50. Further, in order to secure the advantageous effect of the present embodiment further more surely, it is preferable to set the upper limit value of Conditional Expression (10) to 4.25, 4.00, 3.75, and more preferable to 3.50. Meanwhile, it is possible to secure the advantageous effect of the present embodiment more surely by setting the lower limit value of Conditional Expression (10) to 1.75. Further, in order to secure the advantageous effect of the present embodiment further more surely, it is preferable to set the lower limit value of Conditional Expression (10) to 2.00, 2.25, 2.50, 2.75, and more preferable to 3.00.

The optical system OL according to the present embodiment preferably satisfies Conditional Expression (11) shown below.

$$1.5 < TLa / f < 3.5 \qquad ( 11 )$$

in the expression,
f: overall focal length of the optical system OL at focusing on an infinite distance object, and
TLa: optical total length (air-conversion length) of the optical system OL at focusing on an infinite distance object.

Conditional Expression (11) defines the ratio of the optical total length (air-conversion length) of the optical system OL to the overall focal length thereof at focusing on an infinite distance object. By satisfying Conditional Expression (11), the optical system OL can obtain bright and favorable optical performance while achieving size reduction. Meanwhile, it is possible to secure the advantageous effect of the present embodiment more surely by setting the upper limit value of Conditional Expression (11) to 3.45. Further, in order to secure the advantageous effect of the present embodiment further more surely, it is preferable to set the upper limit value of Conditional Expression (11) to 3.35, 3.25, 3.10, and more preferable to 3.00. Meanwhile, it is possible to secure the advantageous effect of the present embodiment more surely by setting the lower limit value of Conditional Expression (11) to 1.75. Further, in order to secure the advantageous effect of the present embodiment further more surely, it is preferable to set the lower limit value of Conditional Expression (11) to 2.00, 2.25, 2.50, and more preferable to 2.75.

Moreover, in the optical system OL according to the present embodiment, the first focusing group GF1 preferably has negative refractive power. With this configuration, the optical system OL can obtain bright and favorable optical performance at image capturing from an infinite distance object to a close distance object while achieving size reduction.

Moreover, in the optical system OL according to the present embodiment, the second focusing group GF2 preferably has positive refractive power. With this configuration, the optical system OL can obtain bright and favorable optical performance at image capturing from an infinite distance object to a close distance object while achieving size reduction.

Note that conditions and configurations described above each achieve an above-described effect, and not all configurations and conditions necessarily need to be satisfied but the above-described effect can be obtained with either conditions or configurations or with either combination of conditions or configurations.

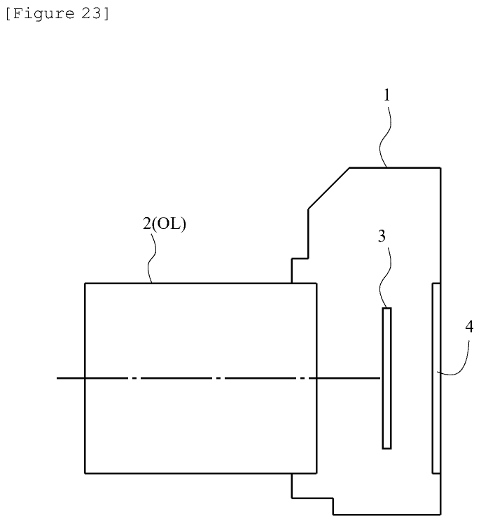

Subsequently, a camera that is an optical apparatus including the optical system OL according to the present embodiment will be described below with reference to FIG. 23. This camera 1 is what is called a mirrorless lens interchangeable camera including the optical system OL according to the present embodiment as an image pickup lens 2. In the camera 1, light from a non-shown object (subject) is condensed through the image pickup lens 2 and forms a subject image on the image surface of an image unit 3 through a non-shown optical low pass filter (OLPF). Then, the subject image is photoelectrically converted by a photoelectric conversion element (image sensor) provided in the image unit 3 and an image of the subject is generated. The image is displayed on an electronic view finder (EVF) 4 provided in the camera 1. Accordingly, a photographer can observe the subject through the EVF 4.

When a non-shown release button is pressed by the photographer, the image photoelectrically converted by the image unit 3 is stored in a non-shown memory. In this manner, the photographer can perform image capturing of the subject with the camera 1. Meanwhile, although the example of a mirrorless camera described in the present embodiment, it is possible to achieve the same effects as those of the camera 1 described above when the optical system OL according to the present embodiment is mounted on a single-lens reflex camera that includes a quick return mirror in a camera body and with which a subject is observed through a finder optical system.

The contents described below are employable as appropriate to the extent that the optical performance is not compromised.

In the present embodiment, the optical system OL having a four-group configuration is shown, and such configurations, conditions, and the like are also applicable to any other group configuration such as a three-group configuration or five-group configuration. Specifically, such a configuration is a configuration in which a lens group having a position fixed relative to the image plane at focusing is added closest to the image plane side. A lens group means a part including at least one lens and separated by an air space that changes at focusing as long as no boundary is designated. A lens component means a single lens or a cemented lens obtained by cementing a plurality of lenses.

A focusing group may be a single lens group, a plurality of lens groups, or a partial lens group moved in the optical axis direction to focus on from an infinite distance object to a close distance object. In this case, the focusing group can also be used to perform autofocusing and is suitably driven by a motor for autofocusing (such as an ultrasonic wave motor). In particular, the focusing group is preferably the first focusing group GF1 and the second focusing group GF2 of the intermediate group Gi, and any other lens preferably has a position fixed relative to the image plane at focusing.

An anti-vibration group may be a lens group or a partial lens group so moved with a displacement component in the direction perpendicular to the optical axis or rotated (swung) in an in-plane direction containing the optical axis to correct an image blur caused by a camera shake.

A lens surface may be so formed as to be a spherical surface, a flat surface, or an aspheric surface. In the case where a lens surface is a spherical or flat surface, the lens is readily processed, assembled, and adjusted, whereby degradation in the optical performance due to errors in the lens processing, assembly, and adjustment is preferably avoided. Further, even when an image plane is shifted, the amount of degradation in drawing performance is preferably small. In the case where the lens surface is an aspheric surface, the aspheric surface may be any of a ground aspheric surface, a glass molded aspheric surface that is a glass surface so molded in a die as to have an aspheric shape, and a composite aspheric surface that is a glass surface on which aspherically shaped resin is formed. The lens surface may instead be a diffractive surface, or the lenses may be any of a distributed index lens (GRIN lens) or a plastic lens.

The aperture stop S is preferably disposed between the first focusing group GF1 and the second focusing group GF2 in the intermediate group Gi. No member as an aperture stop may be provided, and the frame of a lens may serve as the aperture stop.

Further, each lens surface may be provided with an antireflection coating having high transmittance over a wide wavelength range to achieve good optical performance that reduces flare and ghost and achieves high contrast.

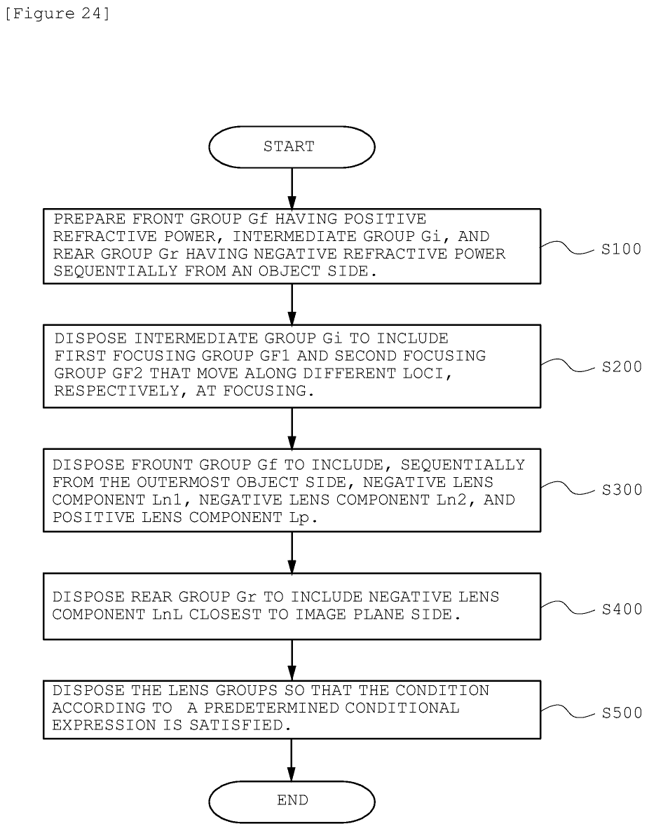

A method for manufacturing the optical system OL according to the present embodiment will be schematically described below with reference to FIG. 24. First, the front group Gf having positive refractive power, the intermediate group Gi, and the rear group Gr having negative refractive power are prepared sequentially from the object side (step S100). Subsequently, the intermediate group Gi is disposed to include the first focusing group GF1 and the second focusing group GF2 that move along different loci, respectively, at focusing (step S200), the front group Gf is disposed to include, sequentially from the outermost object side, a negative lens component Ln1, a negative lens component Ln2, and a positive lens component Lp (step S300), and the rear group Gr is disposed to include the negative lens component LnL closest to the image plane side (step S400). Then, the lens groups are disposed so that a predetermined condition (for example, Conditional Expressions (1) and (2) for the first embodiment or Conditional Expressions (3) and (4) for the second embodiment as described above) is satisfied (step S500).

In this manner, an optical system that can obtain bright and favorable optical performance at image capturing from an infinite distance object to a close distance object while achieving size reduction, an optical apparatus, and a method for manufacturing the optical system can be provided.

### EXAMPLES

Examples will be described below with reference to the accompanying drawings. Note that FIGS. 1, 3, 5, 7, 9, 11, 13, 15, 17, 19, and 21 are cross-sectional views showing the configurations of optical systems OL (OL1 to OL11) according to the examples and the refractive power distribution thereof. At lower parts of these cross-sectional views, arrows show the moving directions of the first focusing group GF1 and the second focusing group GF2 along the optical axis at focusing on from an infinite distance object (o) to a close distance object (close distance).

In the examples, each aspheric surface is expressed by Expression (a) below where y represents the height in a direction perpendicular to the optical axis, S(y) represents the distance (sag amount) on the optical axis from a tangent plane at the apex of the aspheric surface at the height y to the aspheric surface, r represents the radius of curvature (paraxial radius of curvature) of a reference spherical surface, K represents the conic constant, and An represents the n-th aspheric surface coefficient. Note that, in the examples below, “E-n” represents “×10⁻ⁿ”.

$$S ( y ) = ( {y}^{2} / r ) / \{ 1 + {( 1 - K \times {y}^{2} / {r}^{2} )}^{1 / 2} \} + A 4 \times {y}^{4} + A 6 \times {y}^{6} + A 8 \times {y}^{8} + A 10 \times {y}^{10} \qquad ( a )$$

Note that, in the examples, the second aspheric surface coefficient A2 is zero. In tables of the examples, the symbol “*” is attached on the right side of the surface number of an aspheric surface.

### First Example

FIG. 1 shows the configuration of the optical system OL1 according to a first example. The optical system OL1 includes, sequentially from the object side, a front group Gf having positive refractive power, an intermediate group Gi having positive refractive power, and a rear group Gr having negative refractive power. The intermediate group Gi includes a first focusing group GF1 and a second focusing group GF2 that move along different loci, respectively, at focusing, the first focusing group GF1 having negative refractive power, the second focusing group GF2 having positive refractive power.

The front group Gf includes, sequentially from the object side, a negative lens L11 (negative lens component Ln1) in a meniscus shape having a convex surface facing the object side, a negative lens L12 (negative lens component Ln2) in a meniscus shape having a concave surface facing the object side, a positive lens L13 (positive lens component Lp) in a meniscus shape having a concave surface facing the object side, a biconvex positive lens L14, and a positive lens L15 in a meniscus shape having a convex surface facing the object side.

The first focusing group GF1 included in the intermediate group Gi includes a negative lens L21 in a meniscus shape having a convex surface facing the object side. The second focusing group GF2 included in the intermediate group Gi includes, sequentially from the object side, a negative lens L31 in a meniscus shape having a concave surface facing the object side, a biconvex positive lens L32, and a positive lens L33 in a meniscus shape formed with an aspheric lens surface on the object side and having a concave surface facing the object side. Note that the positive lens L33 is a composite lens having an aspheric surface formed of a resin layer provided on the object-side surface of a glass lens body.

The rear group Gr includes a negative lens L41 (negative lens component LnL) in a meniscus shape having a concave surface facing the object side.

The aperture stop S is disposed between the first focusing group GF1 and the second focusing group GF2 of the intermediate group Gi. In addition, an optical filter FL is disposed between the rear group Gr and an image plane I.

In the optical system OL1, at focusing on from an infinite distance object to a close distance object, the front group Gf and the rear group Gr are fixed relative to the image plane I, and the first focusing group GF and the second focusing group GF2 included in the intermediate group Gi move in the optical axis direction. Specifically, the first focusing group GF1 moves to the image plane side, and the second focusing group GF2 moves to the object side. At focusing, the aperture stop S is fixed relative to the image plane I.

Table 1 below shows values of specifications of the optical system OL1. In Table 1, the following specifications shown as overall specifications are defined as follows: f represents the overall focal length; Fno represents the F number; w represents the half angle of view [° ]; Y represents the maximum image height; TL represents the optical total length; and Bf represents the value of the back focus at focusing on an infinite distance object. The back focus Bf represents the distance on the optical axis from the lens surface (twenty-second surface) closest to the image plane side to the image plane I, and its air-conversion length. The optical total length TL represents a length obtained by adding the back focus and its air-conversion length to the distance on the optical axis from the lens surface (first surface) closest to the object side to the lens surface (twenty-second surface) closest to the image plane side. In lens data, a first column m shows the sequence of lens surfaces (surface numbers) counted from the object side in a direction in which a ray travels. A second column r shows the radius of curvature of each lens surface. A third column d shows the distance (inter-surface distance) on the optical axis from each optical surface to the next optical surface. A fourth column nd and a fifth column νd show the refractive index and the Abbe number at the d line (λ=587.6 nm). A radius of curvature of ∞ represents a flat surface, and the refractive index of air, which is 1.0000, is omitted. The lens group focal length shows the surface number of the first surface and the focal length of each lens group.

The unit of each of the focal length f, the radius of curvature r, the inter-surface distance d, and other lengths shown in all the variety of specifications below is typically “mm”, but not limited to this, because an optical system provides the same optical performance even when the optical system is proportionally enlarged or reduced. The above description of symbols and specification tables applies to subsequent examples as well.

TABLE 1
First example
[Overall specifications]

| | |
|---|---|
| f = | 35.700 |
| Fno = | 1.442 |
| ω = | 30.900 |
| Y = | 21.700 |
| TL = | 105.000 |
| TL (air-conversion length) = | 104.455 |
| Bf = | 12.000 |
| Bf (air-conversion length) = | 11.455 |

[Lens data]

| m | r | d | nd | νd | |
|---|---|---|---|---|---|
| Object surface | ∞ | D0 | | | |
| 1 | 82.7897 | 2.1000 | 1.4875 | 70.32 | |
| 2 | 31.2968 | 17.7494 | | | |
| 3 | −35.4308 | 2.1000 | 1.7408 | 27.74 | |
| 4 | −1066.3043 | 2.5966 | | | |
| 5 | −225.6732 | 7.6581 | 1.8040 | 46.60 | |
| 6 | −43.2478 | 0.3000 | | | |
| 7 | 46.6581 | 6.7987 | 1.8040 | 46.60 | |
| 8 | −672.8835 | 0.8000 | | | |
| 9 | 30.6219 | 4.5599 | 1.9027 | 35.77 | |
| 10 | 57.0547 | D10 | | | |
| 11 | 51.9983 | 1.5000 | 1.8467 | 23.80 | |
| 12 | 26.7132 | D12 | | | |
| 13 | ∞ | D13 | | | Aperture stop S |
| 14 | −22.3948 | 1.2000 | 1.8467 | 23.80 | |
| 15 | −290.4653 | 0.2000 | | | |
| 16 | 54.3218 | 8.4941 | 1.7725 | 49.62 | |
| 17 | −30.4208 | 1.0349 | | | |
| 18* | 464.2593 | 0.1500 | 1.5609 | 36.64 | |
| 19 | −169.9067 | 3.6996 | 1.8348 | 42.73 | |
| 20 | −58.6468 | D20 | | | |
| 21 | −43.0181 | 2.0000 | 1.5481 | 45.51 | |
| 22 | −1000.0000 | 10.3000 | | | |
| 23 | ∞ | 1.6000 | 1.5168 | 64.13 | |
| 24 | ∞ | 0.1000 | | | |
| Image plane | ∞ | | | | |

[Focal length of lens groups]

| Lens group | First surface | Focal length |
|---|---|---|
| Front group Gf | 1 | 27.002 |
| First focusing group GF1 | 11 | −66.699 |
| Second focusing group GF2 | 14 | 42.133 |
| Rear group Gr | 21 | −82.069 |

In the optical system OL1, the eighteenth surface is formed in an aspheric shape. Table 2 below shows aspheric surface data, in other words, the values of the conic constant K and the aspheric surface constants A4 to A10.

TABLE 2
[Aspheric surface data]

| m | K | A4 | A6 | A8 | A10 |
|---|---|---|---|---|---|
| 18 | 2.0000 | −2.43566E−05 | 4.85916E−09 | −1.54369E−10 | 1.67442E−13 |

In the optical system OL1, an on-axis air space D10 between the front group Gf and the first focusing group GF1, an on-axis air space D12 between the first focusing group GF1 and the aperture stop S, an on-axis air space D13 between the aperture stop S and the second focusing group GF2, and an on-axis air space D20 between the second focusing group GF2 and the rear group Gr change at focusing. Table 3 below shows variable spaces at focusing on an infinite distance object (infinite distance) and at focusing on a close distance object (close distance). Note that f represents the focal length, β represents the image pickup magnification, and D0 represents the distance from the lens surface (first surface) closest to the object side in the optical system OL1 to an object. This description applies to subsequent examples as well.

TABLE 3
[Variable space data]

| Focusing state | Infinite distance | Close distance |
|---|---|---|
| f | 35.700 | — |
| β | — | −0.160 |
| D0 | ∞ | 190.0000 |
| D10 | 2.0000 | 2.7939 |
| D12 | 7.5934 | 6.8000 |
| D13 | 11.5784 | 6.2646 |
| D20 | 8.8871 | 14.2008 |

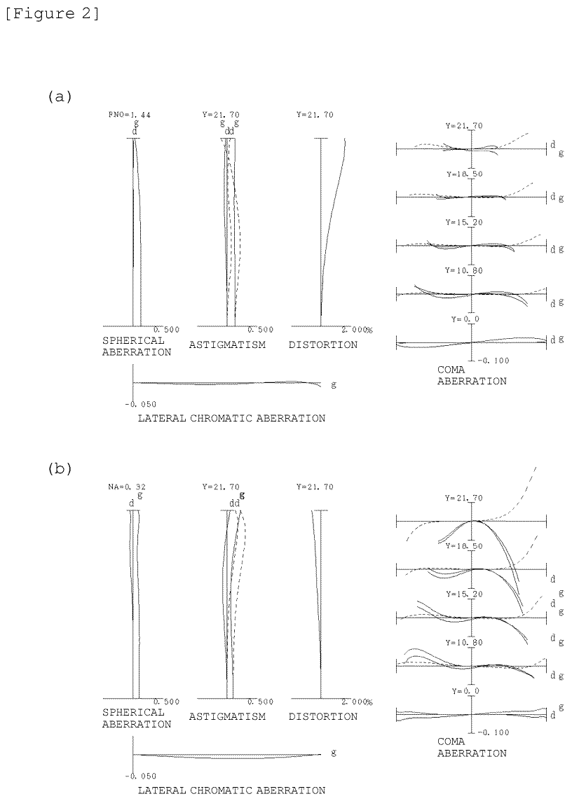

FIG. 2 shows a spherical aberration diagram, an astigmatism diagram, a distortion diagram, a lateral chromatic aberration diagram, and a coma aberration diagram of the optical system OL1 at focusing on an infinite distance object and at focusing on a close distance object. In each aberration diagram, FNO represents the F number, NA represents the aperture number, and Y represents the image height. Note that the spherical aberration diagram shows the value of the F number or the aperture number corresponding to the maximum diameter, the astigmatism diagram and the distortion diagram shows the maximum value of the image height, and the coma aberration diagram shows the value of each image height. In addition, reference character d represents the d-line (λ=587.6 nm), and reference character g represents the g-line (λ=435.8 nm). In the astigmatism diagram and the coma aberration diagram, the solid line represents the sagittal image plane, and the dashed line represents the meridional image plane. Further, in the aberration diagrams in the following examples, the same reference characters as those in the present example are used. The aberration diagrams show that the optical system OL1 allows favorable correction of the variety of aberrations and has excellent imaging performance.

### Second Example

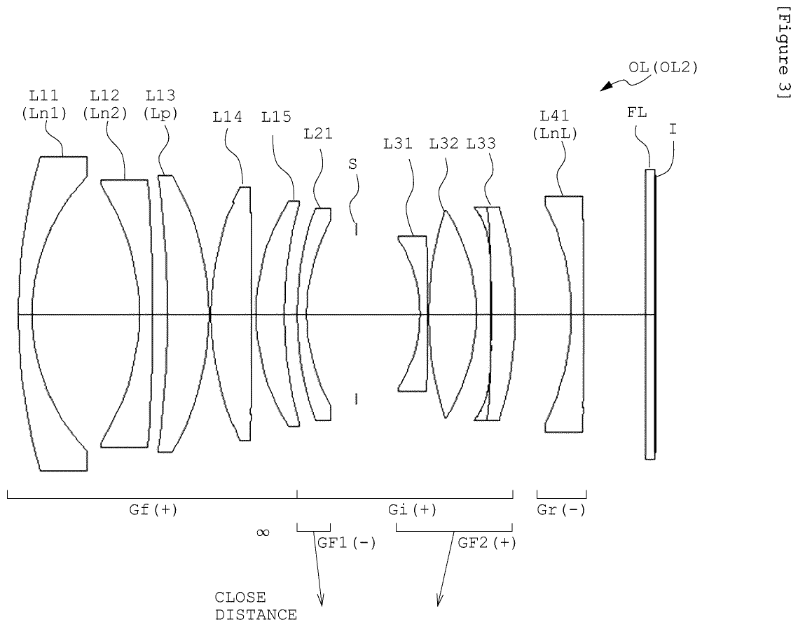

FIG. 3 shows the configuration of the optical system OL2 according to a second example. The optical system OL2 includes, sequentially from the object side, a front group Gf having positive refractive power, an intermediate group Gi having positive refractive power, and a rear group Gr having negative refractive power. The intermediate group Gi includes a first focusing group GF1 and a second focusing group GF2 that move along different loci, respectively, at focusing, the first focusing group GF1 having negative refractive power, the second focusing group GF2 having positive refractive power.

The front group Gf includes, sequentially from the object side, a negative lens L11 (negative lens component Ln1) in a meniscus shape having a convex surface facing the object side, a negative lens L12 (negative lens component Ln2) in a meniscus shape having a concave surface facing the object side, a positive lens L13 (positive lens component Lp) in a meniscus shape having a concave surface facing the object side, a biconvex positive lens L14, and a positive lens L15 in a meniscus shape having a convex surface facing the object side.

The first focusing group GF1 included in the intermediate group Gi includes a negative lens L21 in a meniscus shape having a convex surface facing the object side. The second focusing group GF2 included in the intermediate group Gi includes, sequentially from the object side, a negative lens L31 in a meniscus shape having a concave surface facing the object side, a biconvex positive lens L32, and a positive lens L33 in a meniscus shape formed with an aspheric lens surface on the object side and having a concave surface facing the object side. Note that the positive lens L33 is a composite lens having an aspheric surface formed of a resin layer provided on the object-side surface of a glass lens body.

The rear group Gr includes a negative lens L41 (negative lens component LnL) in a meniscus shape having a concave surface facing the object side.

The aperture stop S is disposed between the first focusing group GF1 and the second focusing group GF2 of the intermediate group Gi. In addition, an optical filter FL is disposed between the rear group Gr and an image plane I.

In the optical system OL2, at focusing on from an infinite distance object to a close distance object, the front group Gf and the rear group Gr are fixed relative to the image plane I, and the first focusing group GF and the second focusing group GF2 included in the intermediate group Gi move in the optical axis direction. Specifically, the first focusing group GF1 moves to the image plane side, and the second focusing group GF2 moves to the object side. At focusing, the aperture stop S is fixed relative to the image plane I.

Table 4 below shows values of specifications of the optical system OL2.

TABLE 4
Second example
[Overall specifications]

| | |
|---|---|
| f = | 35.000 |
| Fno = | 1.442 |
| ω = | 31.061 |
| Y = | 21.700 |
| TL = | 100.000 |
| TL (air-conversion length) = | 99.455 |
| Bf = | 11.300 |
| Bf (air-conversion length) = | 10.755 |

[Lens data]

| m | r | d | nd | νd | |
|---|---|---|---|---|---|
| Object surface | ∞ | D0 | | | |
| 1 | 88.8126 | 2.1000 | 1.4875 | 70.32 | |
| 2 | 30.9465 | 16.8770 | | | |
| 3 | −36.6582 | 2.1000 | 1.7847 | 25.64 | |
| 4 | −279.6052 | 2.3261 | | | |
| 5 | −158.8776 | 6.5233 | 1.8040 | 46.60 | |
| 6 | −43.6434 | 0.3000 | | | |
| 7 | 45.3198 | 6.2825 | 1.8040 | 46.60 | |
| 8 | −3114.6501 | 0.8000 | | | |
| 9 | 32.9258 | 4.3993 | 1.9027 | 35.77 | |
| 10 | 57.0547 | D10 | | | |
| 11 | 48.6052 | 1.5000 | 1.8467 | 23.80 | |
| 12 | 29.3484 | D12 | | | |
| 13 | ∞ | D13 | | | Aperature stop S |
| 14 | −21.7847 | 1.2000 | 1.8467 | 23.80 | |
| 15 | −465.4177 | 0.2000 | | | |
| 16 | 53.5172 | 7.4334 | 1.8040 | 46.60 | |
| 17 | −30.4858 | 2.2204 | | | |
| 18* | 341.1237 | 0.1500 | 1.5609 | 36.64 | |
| 19 | −229.5001 | 3.7677 | 1.8348 | 42.73 | |
| 20 | −57.2915 | D20 | | | |
| 21 | −38.4099 | 2.0000 | 1.6200 | 36.40 | |
| 22 | −1000.0000 | 9.6000 | | | |
| 23 | ∞ | 1.6000 | 1.5168 | 64.13 | |
| 24 | ∞ | 0.1000 | | | |
| Image plane | ∞ | | | | |

[Focal length of lens groups]

| Lens group | First surface | Focal length |
|---|---|---|
| Front group Gf | 1 | 29.924 |
| First focusing group GF1 | 11 | −90.733 |
| Second focusing group GF2 | 14 | 41.006 |
| Rear group Gr | 21 | −64.473 |

In the optical system OL2, the eighteenth surface is formed in an aspheric shape. Table 5 below shows aspheric surface data, in other words, the values of the conic constant K and the aspheric surface constants A4 to A10.

TABLE 5
[Aspheric surface data]

| m | K | A4 | A6 | A8 | A10 |
|---|---|---|---|---|---|
| 18 | 1.2573 | −2.82945E−05 | 1.54522E−08 | −2.68347E−10 | 3.16313E−13 |

In the optical system OL2, an on-axis air space D10 between the front group Gf and the first focusing group GF1, an on-axis air space D12 between the first focusing group GF1 and the aperture stop S, an on-axis air space D13 between the aperture stop S and the second focusing group GF2, and an on-axis air space D20 between the second focusing group GF2 and the rear group Gr change at focusing. Table 6 below shows variable spaces at focusing on an infinite distance object (infinite distance) and at focusing on a close distance object (close distance).

TABLE 6
[Variable space data]

| Focusing state | Infinite distance | Close distance |
|---|---|---|
| f | 35.000 | — |
| β | — | −0.158 |
| D0 | ∞ | 190.0000 |
| D10 | 2.0000 | 2.9267 |
| D12 | 7.7258 | 6.8000 |
| D13 | 10.0632 | 5.0266 |
| D20 | 8.7313 | 13.7679 |

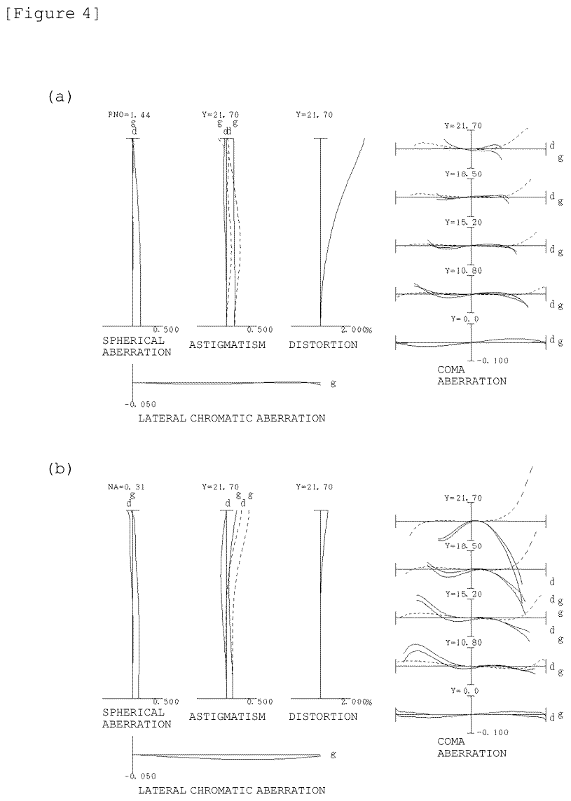

FIG. 4 shows a spherical aberration diagram, an astigmatism diagram, a distortion diagram, a lateral chromatic aberration diagram, and a coma aberration diagram of the optical system OL2 at focusing on an infinite distance object and at focusing on a close distance object. The aberration diagrams show that the optical system OL2 allows favorable correction of the variety of aberrations and has excellent imaging performance.

### Third Example

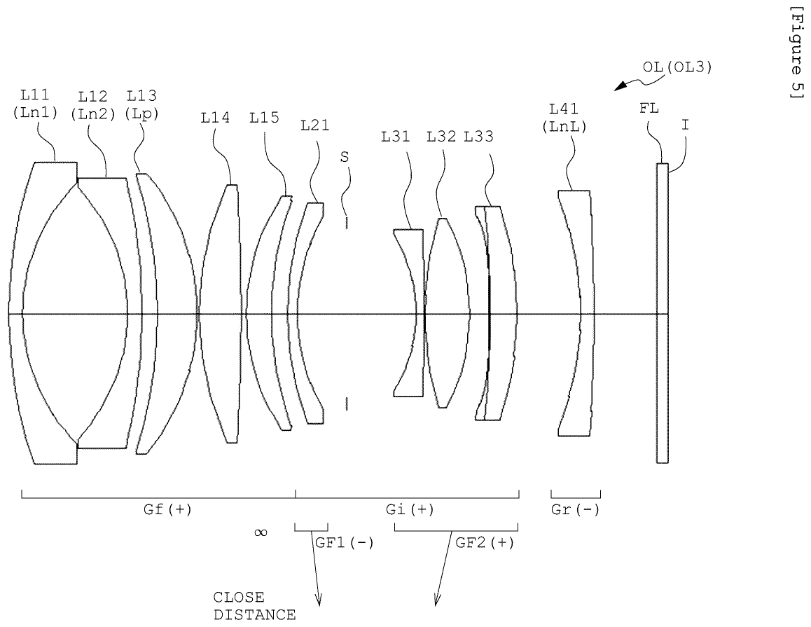

FIG. 5 shows the configuration of the optical system OL3 according to a third example. The optical system OL3 includes, sequentially from the object side, a front group Gf having positive refractive power, an intermediate group Gi having positive refractive power, and a rear group Gr having negative refractive power. The intermediate group Gi includes a first focusing group GF1 and a second focusing group GF2 that move along different loci, respectively, at focusing, the first focusing group GF1 having negative refractive power, the second focusing group GF2 having positive refractive power.

The front group Gf includes, sequentially from the object side, a negative lens L11 (negative lens component Ln1) in a meniscus shape having a convex surface facing the object side, a negative lens L12 (negative lens component Ln2) in a meniscus shape having a concave surface facing the object side, a positive lens L13 (positive lens component Lp) in a meniscus shape having a concave surface facing the object side, a biconvex positive lens L14, and a positive lens L15 in a meniscus shape having a convex surface facing the object side.

The first focusing group GF1 included in the intermediate group Gi includes a negative lens L21 in a meniscus shape having a convex surface facing the object side. The second focusing group GF2 included in the intermediate group Gi includes, sequentially from the object side, a negative lens L31 in a meniscus shape having a concave surface facing the object side, a biconvex positive lens L32, and a positive lens L33 in a meniscus shape formed with an aspheric lens surface on the object side and having a concave surface facing the object side. Note that the positive lens L33 is a composite lens having an aspheric surface formed of a resin layer provided on the object-side surface of a glass lens body.

The rear group Gr includes a negative lens L41 (negative lens component LnL) in a meniscus shape having a concave surface facing the object side.

The aperture stop S is disposed between the first focusing group GF1 and the second focusing group GF2 of the intermediate group Gi. In addition, an optical filter FL is disposed between the rear group Gr and an image plane I.

In the optical system OL3, at focusing on from an infinite distance object to a close distance object, the front group Gf and the rear group Gr are fixed relative to the image plane I, and the first focusing group GF and the second focusing group GF2 included in the intermediate group Gi move in the optical axis direction. Specifically, the first focusing group GF1 moves to the image plane side, and the second focusing group GF2 moves to the object side. At focusing, the aperture stop S is fixed relative to the image plane I.

Table 7 below shows values of specifications of the optical system OL3.

TABLE 7
Third example
[Overall specifications]
f = 35.004
Fno = 1.442
ω = 32.227
Y = 21.700
TL = 100.000
TL (air-conversion length) = 99.455
Bf = 11.300
Bf (air-conversion length) = 10.755
[Lens data]

| m | r | d | nd | νd |
|---|---|---|---|---|
| Object surface | ∞ | D0 | | |
| 1 | 70.0000 | 2.1000 | 1.4875 | 70.32 |
| 2 | 27.8076 | 15.9479 | | |
| 3 | −27.7600 | 2.1000 | 1.7847 | 25.64 |
| 4 | −88.4056 | 2.4473 | | |
| 5 | −68.4170 | 5.9798 | 1.8040 | 46.60 |
| 6 | −33.0452 | 0.3000 | | |
| 7 | 46.4960 | 6.3477 | 1.8040 | 46.60 |
| 8 | −325.7812 | 0.8000 | | |
| 9 | 31.7826 | 3.8120 | 1.9027 | 35.77 |
| 10 | 49.6250 | D10 | | |
| 11 | 47.4333 | 1.5000 | 1.8467 | 23.80 |
| 12 | 29.3484 | D12 | | |
| 13 | ∞ | D13 | | |
| 14 | −22.7961 | 1.2000 | 1.8467 | 23.80 |
| 15 | −493.1943 | 0.2000 | | |
| 16 | 52.7692 | 6.7281 | 1.8040 | 46.60 |
| 17 | −31.6096 | 2.9836 | | |
| 18* | −328.5131 | 0.1500 | 1.5609 | 36.64 |
| 19 | −155.9434 | 4.0337 | 1.8348 | 42.73 |
| 20 | −52.0479 | D20 | | |
| 21 | −46.4145 | 2.0000 | 1.6200 | 36.40 |
| 22 | −298.7014 | 9.5998 | | |
| 23 | ∞ | 1.6000 | 1.5168 | 64.13 |
| 24 | ∞ | 0.1000 | | |
| Image plane | ∞ | | | |

[Focal length of lens groups]

| Lens group | First surface | Focal length |
|---|---|---|
| Front group Gf | 1 | 30.926 |
| First focusing group GF1 | 11 | −94.510 |
| Second focusing group GF2 | 14 | 45.820 |
| Rear group Gr | 21 | −88.899 |

In the optical system OL3, the eighteenth surface is formed in an aspheric shape. Table 8 below shows aspheric surface data, in other words, the values of the conic constant K and the aspheric surface constants A4 to A10.

TABLE 8
[Aspheric surface data]

| m | K | A4 | A6 | A8 | A10 |
|---|---|---|---|---|---|
| 18 | 2.0000 | −2.71006E−05 | 1.03066E−09 | −1.82845E−10 | 2.03855E−13 |

In the optical system OL3, an on-axis air space D10 between the front group Gf and the first focusing group GF1, an on-axis air space D12 between the first focusing group GF1 and the aperture stop S, an on-axis air space D13 between the aperture stop S and the second focusing group GF2, and an on-axis air space D20 between the second focusing group GF2 and the rear group Gr change at focusing. Table 9 below shows variable spaces at focusing on an infinite distance object (infinite distance) and at focusing on a close distance object (close distance).

TABLE 9
[Variable space data]

| Focusing state | Infinite distance | Close distance |
|---|---|---|
| f | 35.004 | — |
| β | — | −0.161 |
| D0 | ∞ | 189.9999 |
| D10 | 2.4304 | 3.8885 |
| D12 | 7.4378 | 5.9801 |
| D13 | 10.5270 | 5.2544 |
| D20 | 9.6746 | 14.9472 |

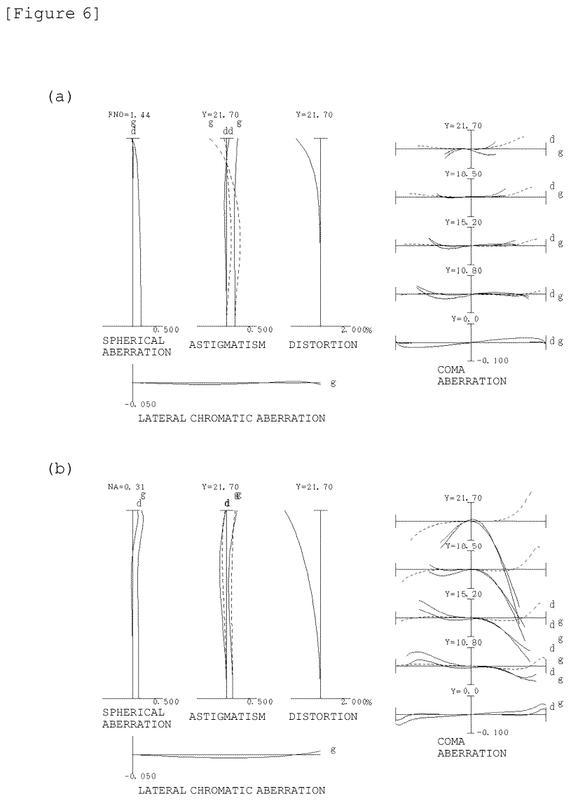

FIG. 6 shows a spherical aberration diagram, an astigmatism diagram, a distortion diagram, a lateral chromatic aberration diagram, and a coma aberration diagram of the optical system OL3 at focusing on an infinite distance object and at focusing on a close distance object. The aberration diagrams show that the optical system OL3 allows favorable correction of the variety of aberrations and has excellent imaging performance.

### Fourth Example

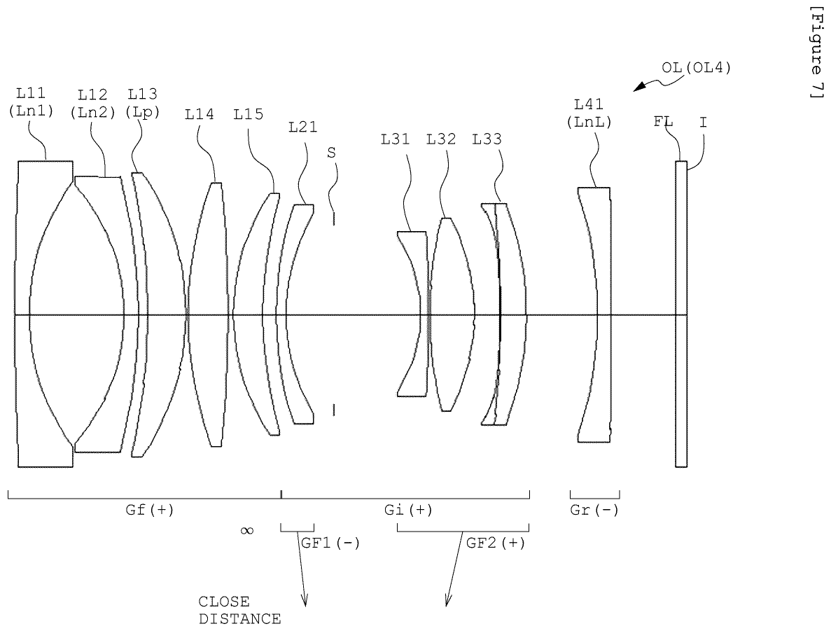

FIG. 7 shows the configuration of the optical system OL4 according to a fourth example. The optical system OL4 includes, sequentially from the object side, a front group Gf having positive refractive power, an intermediate group Gi having positive refractive power, and a rear group Gr having negative refractive power. The intermediate group Gi includes a first focusing group GF1 and a second focusing group GF2 that move along different loci, respectively, at focusing, the first focusing group GF1 having negative refractive power, the second focusing group GF2 having positive refractive power.

The front group Gf includes, sequentially from the object side, a negative lens L11 (negative lens component Ln1) in a meniscus shape having a convex surface facing the object side, a negative lens L12 (negative lens component Ln2) in a meniscus shape having a concave surface facing the object side, a positive lens L13 (positive lens component Lp) in a meniscus shape having a concave surface facing the object side, a biconvex positive lens L14, and a positive lens L15 in a meniscus shape having a convex surface facing the object side.

The first focusing group GF1 included in the intermediate group Gi includes a negative lens L21 in a meniscus shape having a convex surface facing the object side. The second focusing group GF2 included in the intermediate group Gi includes, sequentially from the object side, a negative lens L31 in a meniscus shape having a concave surface facing the object side, a biconvex positive lens L32, and a positive lens L33 in a meniscus shape formed with an aspheric lens surface on the object side and having a concave surface facing the object side. Note that the positive lens L33 is a composite lens having an aspheric surface formed of a resin layer provided on the object-side surface of a glass lens body.

The rear group Gr includes a negative lens L41 (negative lens component LnL) in a meniscus shape having a concave surface facing the object side.

The aperture stop S is disposed between the first focusing group GF1 and the second focusing group GF2 of the intermediate group Gi. In addition, an optical filter FL is disposed between the rear group Gr and an image plane I.

In the optical system OL4, at focusing on from an infinite distance object to a close distance object, the front group Gf and the rear group Gr are fixed relative to the image plane I, and the first focusing group GF and the second focusing group GF2 included in the intermediate group Gi move in the optical axis direction. Specifically, the first focusing group GF1 moves to the image plane side, and the second focusing group GF2 moves to the object side. At focusing, the aperture stop S is fixed relative to the image plane I.

Table 10 below shows values of specifications of the optical system OL4.

TABLE 10
Fourth example
[Overall specifications]
f = 35.000
Fno = 1.442
ω = 32.410
Y = 21.700
TL = 100.000
TL (air-conversion length) = 99.455
Bf = 11.300
Bf (air-conversion length) = 10.755
[Lens data]

| m | r | d | nd | νd |
|---|---|---|---|---|
| Object surface | ∞ | D0 | | |
| 1 | 453.9917 | 2.1000 | 1.4875 | 70.32 |
| 2 | 32.9891 | 14.1586 | | |
| 3 | −28.8733 | 2.1000 | 1.7847 | 25.64 |
| 4 | −77.9481 | 1.3961 | | |
| 5 | −91.3553 | 5.6962 | 1.8040 | 46.60 |
| 6 | −37.3200 | 0.3000 | | |
| 7 | 57.9831 | 5.9384 | 1.8040 | 46.60 |
| 8 | −192.5850 | 0.8000 | | |
| 9 | 32.3697 | 4.3768 | 1.9027 | 35.77 |
| 10 | 63.1524 | D10 | | |
| 11 | 51.0263 | 1.5000 | 1.8467 | 23.80 |
| 12 | 29.3484 | D12 | | |
| 13 | ∞ | D13 | | Aperature stop S |
| 14 | −21.1760 | 1.2000 | 1.8467 | 23.80 |
| 15 | −196.5752 | 0.2000 | | |
| 16 | 59.7795 | 6.6230 | 1.8040 | 46.60 |
| 17 | −30.6517 | 3.7474 | | |
| 18* | −303.1727 | 0.1500 | 1.5609 | 36.64 |
| 19 | −151.1251 | 3.8320 | 1.8348 | 42.73 |
| 20 | −46.3491 | D20 | | |
| 21 | −56.5734 | 2.0000 | 1.6200 | 36.40 |
| 22 | −1200.0000 | 9.5998 | | |
| 23 | ∞ | 1.6000 | 1.5168 | 64.13 |
| 24 | ∞ | 0.1000 | | |
| Image plane | ∞ | | | |

[Focal length of lens groups]

| Lens group | First surface | Focal length |
|---|---|---|
| Front group Gf | 1 | 30.549 |
| First focusing group GF1 | 11 | −84.266 |
| Second focusing group GF2 | 14 | 43.601 |
| Rear group Gr | 21 | −95.820 |

In the optical system OL4, the eighteenth surface is formed in an aspheric shape. Table 11 below shows aspheric surface data, in other words, the values of the conic constant K and the aspheric surface constants A4 to A10.

TABLE 11
[Aspheric surface data]

| m | K | A4 | A6 | A8 | A10 |
|---|---|---|---|---|---|
| 18 | 2.0000 | −2.57563E−05 | −1.05201E−09 | −1.22355E−10 | 4.87758E−14 |

In the optical system OL4, an on-axis air space D10 between the front group Gf and the first focusing group GF1, an on-axis air space D12 between the first focusing group GF1 and the aperture stop S, an on-axis air space D13 between the aperture stop S and the second focusing group GF2, and an on-axis air space D20 between the second focusing group GF2 and the rear group Gr change at focusing. Table 12 below shows variable spaces at focusing on an infinite distance object (infinite distance) and at focusing on a close distance object (close distance).

TABLE 12
[Variable space data]

| Focusing state | Infinite distance | Close distance |
|---|---|---|
| f | 35.000 | — |
| β | — | −0.162 |
| D0 | ∞ | 189.9999 |
| D10 | 2.0000 | 2.7471 |
| D12 | 7.0747 | 6.3283 |
| D13 | 12.8891 | 7.3895 |
| D20 | 10.6178 | 16.1174 |

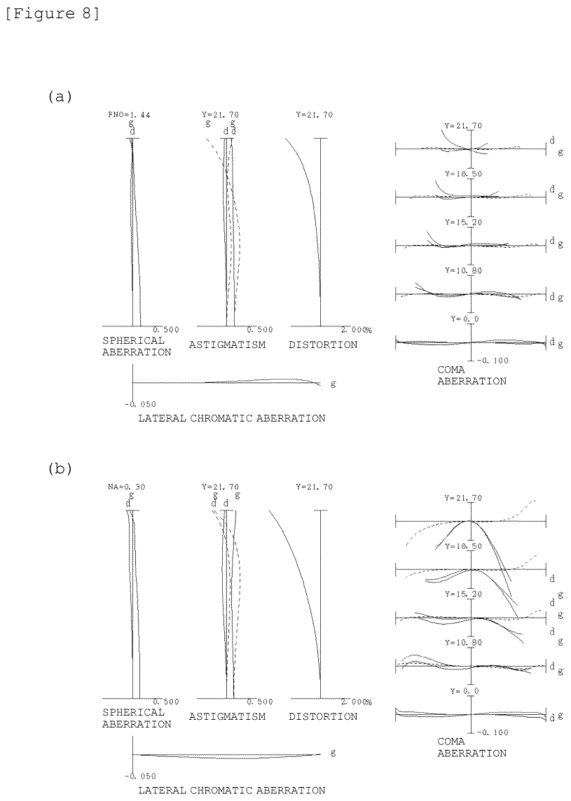

FIG. 8 shows a spherical aberration diagram, an astigmatism diagram, a distortion diagram, a lateral chromatic aberration diagram, and a coma aberration diagram of the optical system OL4 at focusing on an infinite distance object and at focusing on a close distance object. The aberration diagrams show that the optical system OL4 allows favorable correction of the variety of aberrations and has excellent imaging performance.

### Fifth Example

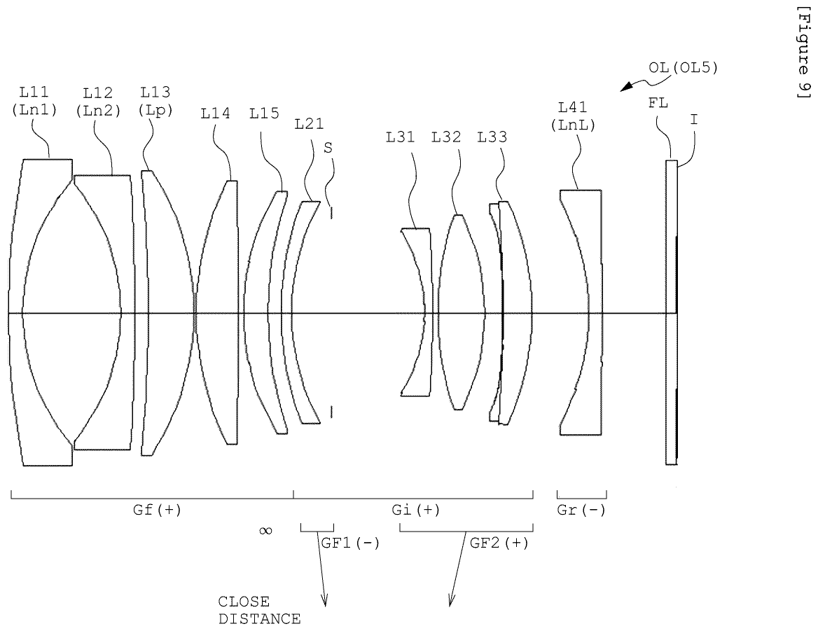

FIG. 9 shows the configuration of the optical system OL5 according to a fifth example. The optical system OL5 includes, sequentially from the object side, a front group Gf having positive refractive power, an intermediate group Gi having positive refractive power, and a rear group Gr having negative refractive power. The intermediate group Gi includes a first focusing group GF1 and a second focusing group GF2 that move along different loci, respectively, at focusing, the first focusing group GF1 having negative refractive power, the second focusing group GF2 having positive refractive power.

The front group Gf includes, sequentially from the object side, a negative lens L11 (negative lens component Ln1) in a meniscus shape having a convex surface facing the object side, a negative lens L12 (negative lens component Ln2) in a meniscus shape having a concave surface facing the object side, a positive lens L13 (positive lens component Lp) in a meniscus shape having a concave surface facing the object side, a biconvex positive lens L14, and a positive lens L15 in a meniscus shape having a convex surface facing the object side.

The first focusing group GF1 included in the intermediate group Gi includes a negative lens L21 in a meniscus shape having a convex surface facing the object side. The second focusing group GF2 included in the intermediate group Gi includes, sequentially from the object side, a negative lens L31 in a meniscus shape having a concave surface facing the object side, a biconvex positive lens L32, and a positive lens L33 in a meniscus shape formed with an aspheric lens surface on the object side and having a concave surface facing the object side. Note that the positive lens L33 is a composite lens having an aspheric surface formed of a resin layer provided on the object-side surface of a glass lens body.

The rear group Gr includes a negative lens L41 (negative lens component LnL) in a meniscus shape having a concave surface facing the object side.

The aperture stop S is disposed between the first focusing group GF1 and the second focusing group GF2 of the intermediate group Gi. In addition, an optical filter FL is disposed between the rear group Gr and an image plane I.

In the optical system OL5, at focusing on from an infinite distance object to a close distance object, the front group Gf and the rear group Gr are fixed relative to the image plane I, and the first focusing group GF and the second focusing group GF2 included in the intermediate group Gi move in the optical axis direction. Specifically, the first focusing group GF1 moves to the image plane side, and the second focusing group GF2 moves to the object side. At focusing, the aperture stop S is fixed relative to the image plane I.

Table 13 below shows values of specifications of the optical system OL5.

TABLE 13
Fifth example
[Overall specifications]
f = 35.000
Fno = 1.442
ω = 32.176
Y = 21.700
TL = 100.000
TL (air-conversion length) = 99.455
Bf = 11.300
Bf (air-conversion length) = 10.755
[Lens data]

| m | r | d | nd | vd |
|---|---|---|---|---|
| Object surface | ∞ | D0 | | |
| 1 | 118.2419 | 2.1000 | 1.4875 | 70.32 |
| 2 | 30.2341 | 14.6776 | | |
| 3 | −29.9891 | 2.1000 | 1.7408 | 27.74 |
| 4 | −326.2351 | 1.9956 | | |
| 5 | −226.0928 | 6.8556 | 1.8040 | 46.60 |
| 6 | −38.5866 | 0.3000 | | |
| 7 | 44.3939 | 6.3148 | 1.8040 | 46.60 |
| 8 | −819.6110 | 0.8000 | | |
| 9 | 35.3850 | 3.6514 | 1.9027 | 35.77 |
| 10 | 56.2433 | D10 | | |
| 11 | 46.7666 | 1.5000 | 1.8467 | 23.80 |
| 12 | 33.2734 | D12 | | |
| 13 | ∞ | D13 | | Aperature stop S |
| 14 | −22.7055 | 1.2000 | 1.8467 | 23.80 |
| 15 | −193.8248 | 0.8240 | | |
| 16 | 45.5896 | 6.9922 | 1.7725 | 49.62 |
| 17 | −32.9670 | 2.5930 | | |
| 18* | −640.7956 | 0.1500 | 1.5609 | 36.64 |
| 19 | −191.7593 | 4.2930 | 1.8348 | 42.73 |
| 20 | −40.1779 | D20 | | |
| 21 | −35.2341 | 2.0000 | 1.5481 | 45.51 |
| 22 | −1200.0000 | 9.6000 | | |
| 23 | ∞ | 1.6000 | 1.5168 | 64.13 |
| 24 | ∞ | 0.1000 | | |
| Image plane | ∞ | | | |

[Focal length of lens groups]

| Lens group | First surface | Focal length |
|---|---|---|
| Front group Gf | 1 | 35.119 |
| First focusing group GF1 | 11 | −150.700 |
| Second focusing group GF2 | 14 | 41.802 |
| Rear group Gr | 21 | −64.025 |

In the optical system OL5, the eighteenth surface is formed in an aspheric shape. Table 14 below shows aspheric surface data, in other words, the values of the conic constant K and the aspheric surface constants A4 to A10.

TABLE 14
[Aspheric surface data]

| m | K | A4 | A6 | A8 | A 10 |
|---|---|---|---|---|---|
| 18 | 0.0000 | −2.81837E−05 | −6.16363E−9 | −1.35046E−10 | 1.96186E−13 |

In the optical system OL5, an on-axis air space D10 between the front group Gf and the first focusing group GF1, an on-axis air space D12 between the first focusing group GF1 and the aperture stop S, an on-axis air space D13 between the aperture stop S and the second focusing group GF2, and an on-axis air space D20 between the second focusing group GF2 and the rear group Gr change at focusing. Table 15 below shows variable spaces at focusing on an infinite distance object (infinite distance) and at focusing on a close distance object (close distance).

TABLE 15
[Variable space data]

| Focusing state | Infinite distance | Close distance |
|---|---|---|
| f | 35.000 | — |
| β | — | −0.158 |
| D0 | ∞ | 189.9999 |
| D10 | 2.0000 | 2.3321 |
| D12 | 5.9821 | 5.6501 |
| D13 | 13.9046 | 8.4797 |
| D20 | 8.4661 | 13.8910 |

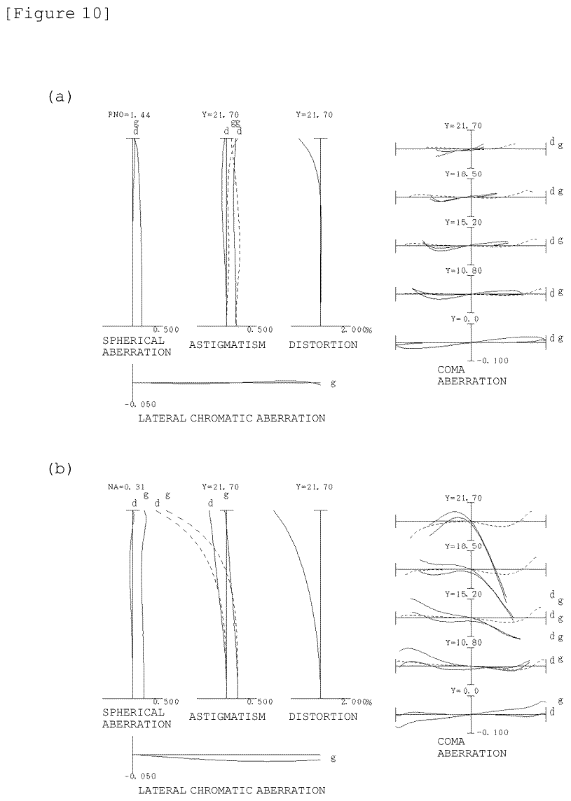

FIG. 10 shows a spherical aberration diagram, an astigmatism diagram, a distortion diagram, a lateral chromatic aberration diagram, and a coma aberration diagram of the optical system OL5 at focusing on an infinite distance object and at focusing on a close distance object. The aberration diagrams show that the optical system OL5 allows favorable correction of the variety of aberrations and has excellent imaging performance.

### Sixth Example

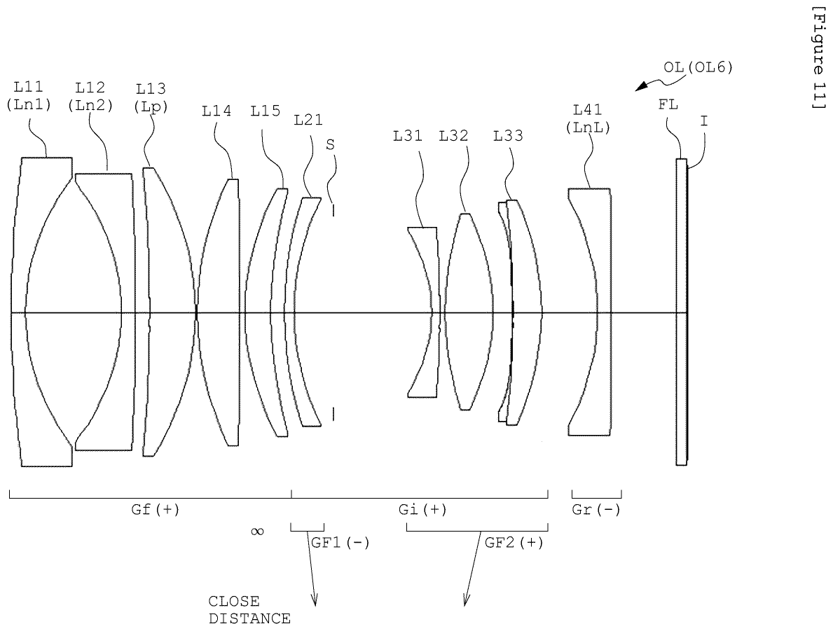

FIG. 11 shows the configuration of the optical system OL6 according to a sixth example. The optical system OL6 includes, sequentially from the object side, a front group Gf having positive refractive power, an intermediate group Gi having positive refractive power, and a rear group Gr having negative refractive power. The intermediate group Gi includes a first focusing group GF1 and a second focusing group GF2 that move along different loci, respectively, at focusing, the first focusing group GF1 having negative refractive power, the second focusing group GF2 having positive refractive power.

The front group Gf includes, sequentially from the object side, a negative lens L11 (negative lens component Ln1) in a meniscus shape having a convex surface facing the object side, a negative lens L12 (negative lens component Ln2) in a meniscus shape having a concave surface facing the object side, a positive lens L13 (positive lens component Lp) in a meniscus shape having a concave surface facing the object side, a biconvex positive lens L14, and a positive lens L15 in a meniscus shape having a convex surface facing the object side.

The first focusing group GF1 included in the intermediate group Gi includes a negative lens L21 in a meniscus shape having a convex surface facing the object side. The second focusing group GF2 included in the intermediate group Gi includes, sequentially from the object side, a negative lens L31 in a meniscus shape having a concave surface facing the object side, a biconvex positive lens L32, and a positive lens L33 in a meniscus shape formed with an aspheric lens surface on the object side and having a concave surface facing the object side. Note that the positive lens L33 is a composite lens having an aspheric surface formed of a resin layer provided on the object-side surface of a glass lens body.

The rear group Gr includes a negative lens L41 (negative lens component LnL) in a meniscus shape having a concave surface facing the object side.

The aperture stop S is disposed between the first focusing group GF1 and the second focusing group GF2 of the intermediate group Gi. In addition, an optical filter FL is disposed between the rear group Gr and an image plane I.

In the optical system OL6, at focusing on from an infinite distance object to a close distance object, the front group Gf and the rear group Gr are fixed relative to the image plane I, and the first focusing group GF and the second focusing group GF2 included in the intermediate group Gi move in the optical axis direction. Specifically, the first focusing group GF1 moves to the image plane side, and the second focusing group GF2 moves to the object side. At focusing, the aperture stop S is fixed relative to the image plane I.

Table 16 below shows values of specifications of the optical system OL6.

TABLE 16
Sixth example
[Overall specifications]
f = 35.000
Fno = 1.442
ω = 32.190
Y = 21.700
TL = 100.000
TL (air-conversion length) = 99.455
Bf = 11.300
Bf (air-conversion length) = 10.755
[Lens data]

| m | r | d | nd | νd |
|---|---|---|---|---|
| Object surface | ∞ | D0 | | |
| 1 | 167.9573 | 2.1000 | 1.4875 | 70.32 |
| 2 | 31.8371 | 14.1765 | | |
| 3 | −30.3660 | 2.1000 | 1.7618 | 26.58 |
| 4 | −380.9602 | 2.0473 | | |
| 5 | −234.6729 | 6.8033 | 1.8348 | 42.73 |
| 6 | −39.0911 | 0.3000 | | |
| 7 | 44.5607 | 6.2460 | 1.7725 | 49.62 |
| 8 | −1102.8642 | 0.8000 | | |
| 9 | 37.3917 | 3.7847 | 1.8348 | 42.73 |
| 10 | 65.5508 | D10 | | |
| 11 | 53.9052 | 1.5000 | 1.8052 | 25.45 |
| 12 | 37.2434 | D12 | | |
| 13 | ∞ | D13 | | Aperture stop S |
| 14 | −22.1286 | 1.2000 | 1.8052 | 25.45 |
| 15 | −157.4419 | 0.8144 | | |
| 16 | 46.1527 | 7.0278 | 1.7292 | 54.61 |
| 17 | −32.4823 | 2.8517 | | |
| 18* | −359.9238 | 0.1500 | 1.5609 | 36.64 |
| 19 | −148.1229 | 4.2354 | 1.5638 | 60.71 |
| 20 | −38.8963 | D20 | | |
| 21 | −34.7589 | 2.0000 | 1.5673 | 42.58 |
| 22 | −1200.0000 | 9.6000 | | |
| 23 | ∞ | 1.6000 | 1.5168 | 64.13 |
| 24 | ∞ | 0.1000 | | |
| Image plane | ∞ | | | |

[Focal length of lens groups]

| Lens group | First surface | Focal length |
|---|---|---|
| Front group Gf | 1 | 35.062 |
| First focusing group GF1 | 11 | −155.906 |
| Second focusing group GF2 | 14 | 41.815 |
| Rear group Gr | 21 | −63.136 |

In the optical system OL6, the eighteenth surface is formed in an aspheric shape. Table 17 below shows aspheric surface data, in other words, the values of the conic constant K and the aspheric surface constants A4 to A10.

TABLE 17
[Aspheric surface data]

| m | K | A4 | A6 | A8 | A10 |
|---|---|---|---|---|---|
| 18 | 0.0000 | −2.90042E−05 | −6.17842E−09 | −1.42377E−10 | 2.08208E−13 |

In the optical system OL6, an on-axis air space D10 between the front group Gf and the first focusing group GF1, an on-axis air space D12 between the first focusing group GF1 and the aperture stop S, an on-axis air space D13 between the aperture stop S and the second focusing group GF2, and an on-axis air space D20 between the second focusing group GF2 and the rear group Gr change at focusing. Table 18 below shows variable spaces at focusing on an infinite distance object (infinite distance) and at focusing on a close distance object (close distance).

TABLE 18
[Variable space data]

| Focusing state | Infinite distance | Close distance |
|---|---|---|
| f | 35.000 | — |
| β | — | −0.159 |
| D0 | ∞ | 190.0000 |
| D10 | 2.0000 | 2.4914 |
| D12 | 5.8340 | 5.3428 |
| D13 | 14.4354 | 9.0503 |
| D20 | 8.2934 | 13.6785 |

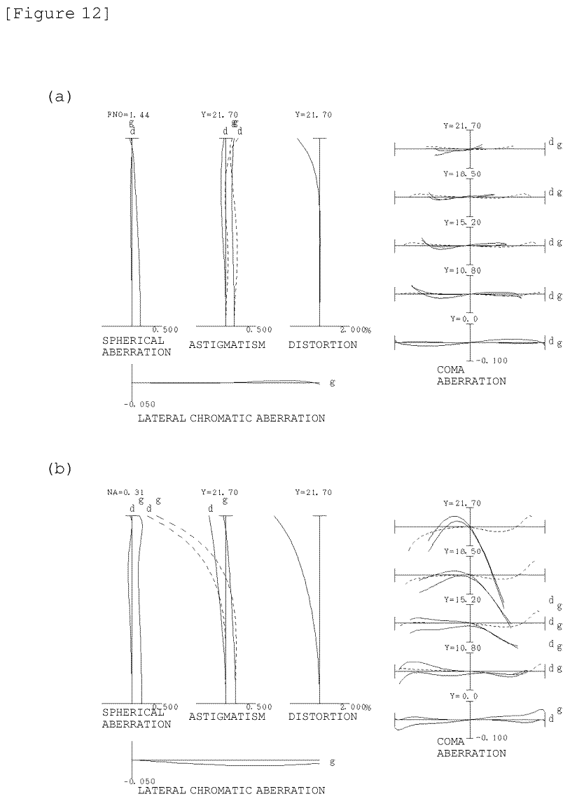

FIG. 12 shows a spherical aberration diagram, an astigmatism diagram, a distortion diagram, a lateral chromatic aberration diagram, and a coma aberration diagram of the optical system OL6 at focusing on an infinite distance object and at focusing on a close distance object. The aberration diagrams show that the optical system OL6 allows favorable correction of the variety of aberrations and has excellent imaging performance.

### Seventh Example

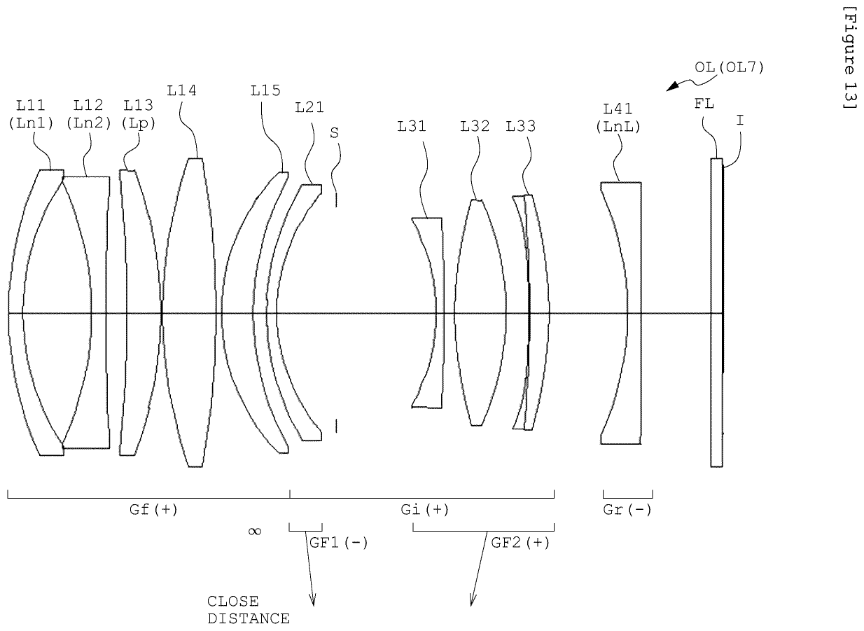

FIG. 13 shows the configuration of the optical system OL7 according to a seventh example. The optical system OL7 includes, sequentially from the object side, a front group Gf having positive refractive power, an intermediate group Gi having positive refractive power, and a rear group Gr having negative refractive power. The intermediate group Gi includes a first focusing group GF1 and a second focusing group GF2 that move along different loci, respectively, at focusing, the first focusing group GF1 having negative refractive power, the second focusing group GF2 having positive refractive power.

The front group Gf includes, sequentially from the object side, a negative lens L11 (negative lens component Ln1) in a meniscus shape having a convex surface facing the object side, a biconcave negative lens L12 (negative lens component Ln2), a positive lens L13 (positive lens component Lp) in a meniscus shape having a concave surface facing the object side, a biconvex positive lens L14, and a positive lens L15 in a meniscus shape having a convex surface facing the object side.

The first focusing group GF1 included in the intermediate group Gi includes a negative lens L21 in a meniscus shape having a convex surface facing the object side. The second focusing group GF2 included in the intermediate group Gi includes, sequentially from the object side, a negative lens L31 in a meniscus shape having a concave surface facing the object side, a biconvex positive lens L32, and a positive lens L33 in a meniscus shape formed with an aspheric lens surface on the object side and having a concave surface facing the object side. Note that the positive lens L33 is a composite lens having an aspheric surface formed of a resin layer provided on the object-side surface of a glass lens body.

The rear group Gr includes a negative lens L41 (negative lens component LnL) in a meniscus shape having a concave surface facing the object side.

The aperture stop S is disposed between the first focusing group GF1 and the second focusing group GF2 of the intermediate group Gi. In addition, an optical filter FL is disposed between the rear group Gr and an image plane I.

In the optical system OL7, at focusing on from an infinite distance object to a close distance object, the front group Gf and the rear group Gr are fixed relative to the image plane I, and the first focusing group GF and the second focusing group GF2 included in the intermediate group Gi move in the optical axis direction. Specifically, the first focusing group GF1 moves to the image plane side, and the second focusing group GF2 moves to the object side. At focusing, the aperture stop S is fixed relative to the image plane I.

Table 19 below shows values of specifications of the optical system OL7.

TABLE 19
Seventh example
[Overall specifications]
f = 50.000
Fno = 1.442
ω = 23.123
Y = 21.700
TL = 105.000
TL (air-conversion length) = 104.455
Bf = 12.000
Bf (air-conversion length) = 11.455
[Lens data]

| m | r | d | nd | νd |
|---|---|---|---|---|
| Object surface | ∞ | D0 | | |
| 1 | 50.0000 | 2.1000 | 1.4875 | 70.32 |
| 2 | 35.0455 | 10.0809 | | |
| 3 | −46.3657 | 2.1000 | 1.7408 | 27.74 |
| 4 | 324.3639 | 3.1649 | | |
| 5 | −181.9354 | 4.9160 | 1.8040 | 46.60 |
| 6 | −58.8772 | 0.3000 | | |
| 7 | 68.0055 | 7.8289 | 1.8040 | 46.60 |
| 8 | −129.6935 | 0.8000 | | |
| 9 | 29.3626 | 4.6462 | 1.9027 | 35.77 |
| 10 | 39.9107 | D10 | | |
| 11 | 36.3460 | 1.5000 | 1.8467 | 23.80 |
| 12 | 26.7132 | D12 | | |
| 13 | ∞ | D13 | | Aperture stop S |
| 14 | −28.0450 | 1.2000 | 1.8467 | 23.80 |
| 15 | −220.6006 | 1.5361 | | |
| 16 | 57.0897 | 7.5510 | 1.7725 | 49.62 |
| 17 | −40.4151 | 3.3222 | | |
| 18* | −168.2320 | 0.1500 | 1.5609 | 36.64 |
| 19 | −171.4018 | 2.8250 | 1.8348 | 42.73 |
| 20 | −60.3031 | D20 | | |
| 21 | −43.4483 | 2.0000 | 1.5481 | 45.51 |
| 22 | −1500.0000 | 10.3000 | | |
| 23 | ∞ | 1.6000 | 1.5168 | 64.13 |
| 24 | ∞ | 0.1000 | | |
| Image plane | ∞ | | | |

[Focal length of lens groups]

| Lens group | First surface | Focal length |
|---|---|---|
| Front group Gf | 1 | 44.666 |
| First focusing group GF1 | 11 | −128.200 |
| Second focusing group GF2 | 14 | 53.103 |
| Rear group Gr | 21 | −81.669 |

In the optical system OL7, the eighteenth surface is formed in an aspheric shape. Table 20 below shows aspheric surface data, in other words, the values of the conic constant K and the aspheric surface constants A4 to A10.

TABLE 20
[Aspheric surface data]

| m | K | A4 | A6 | A8 | A10 |
|---|---|---|---|---|---|
| 18 | 1.7145 | −1.59946E−05 | 4.49820E−09 | −6.47663E−11 | 9.21080E−14 |

In the optical system OL7, an on-axis air space D10 between the front group Gf and the first focusing group GF1, an on-axis air space D12 between the first focusing group GF1 and the aperture stop S, an on-axis air space D13 between the aperture stop S and the second focusing group GF2, and an on-axis air space D20 between the second focusing group GF2 and the rear group Gr change at focusing. Table 21 below shows variable spaces at focusing on an infinite distance object (infinite distance) and at focusing on a close distance object (close distance).

TABLE 21
[Variable space data]

| Focusing state | Infinite distance | Close distance |
|---|---|---|
| f | 50.000 | — |
| β | — | −0.162 |
| D0 | ∞ | 275.0000 |
| D10 | 2.0000 | 3.0438 |
| D12 | 8.7330 | 7.6892 |
| D13 | 14.6734 | 6.4948 |
| D20 | 11.5724 | 19.7510 |

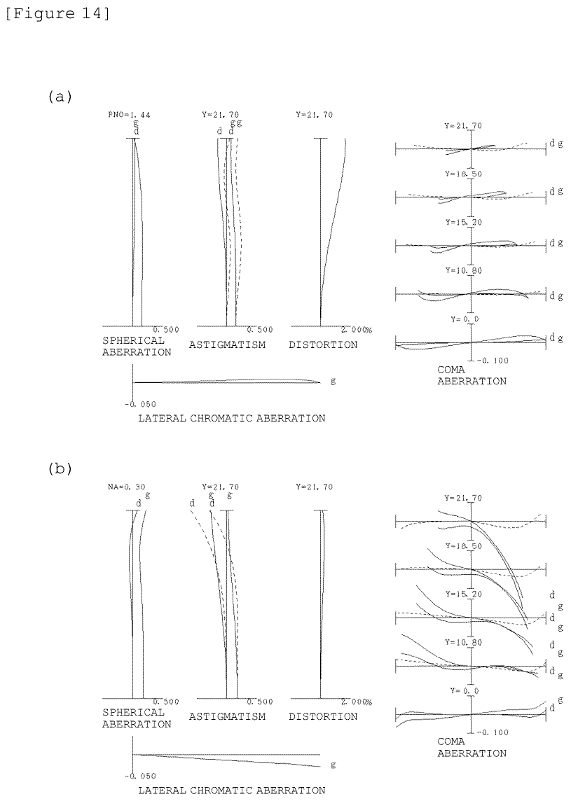

FIG. 14 shows a spherical aberration diagram, an astigmatism diagram, a distortion diagram, a lateral chromatic aberration diagram, and a coma aberration diagram of the optical system OL7 at focusing on an infinite distance object and at focusing on a close distance object. The aberration diagrams show that the optical system OL7 allows favorable correction of the variety of aberrations and has excellent imaging performance.

### Eighth Example

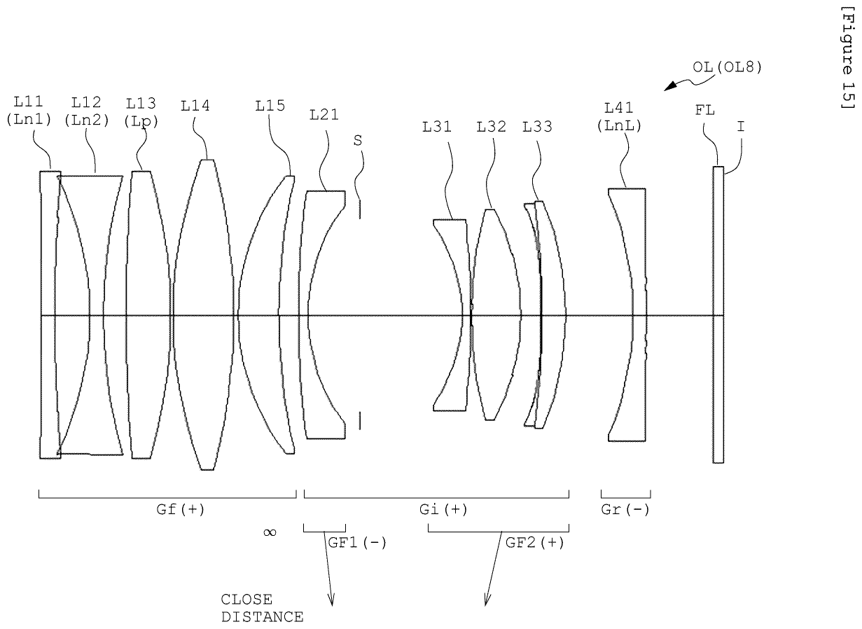

FIG. 15 shows the configuration of the optical system OL8 according to an eighth example. The optical system OL8 includes, sequentially from the object side, a front group Gf having positive refractive power, an intermediate group Gi having positive refractive power, and a rear group Gr having negative refractive power. The intermediate group Gi includes a first focusing group GF1 and a second focusing group GF2 that move along different loci, respectively, at focusing, the first focusing group GF1 having negative refractive power, the second focusing group GF2 having positive refractive power.

The front group Gf includes, sequentially from the object side, a biconcave negative lens L11 (negative lens component Ln1), a biconcave negative lens L12 (negative lens component Ln2), a biconvex positive lens L13 (positive lens component Lp), a biconvex positive lens L14, and a positive lens L15 in a meniscus shape having a convex surface facing the object side.

The first focusing group GF1 included in the intermediate group Gi includes a negative lens L21 in a meniscus shape having a convex surface facing the object side. The second focusing group GF2 included in the intermediate group Gi includes, sequentially from the object side, a negative lens L31 in a meniscus shape having a concave surface facing the object side, a biconvex positive lens L32, and a positive lens L33 in a meniscus shape formed with an aspheric lens surface on the object side and having a concave surface facing the object side. Note that the positive lens L33 is a composite lens having an aspheric surface formed of a resin layer provided on the object-side surface of a glass lens body.

The rear group Gr includes a negative lens L41 (negative lens component LnL) in a meniscus shape having a concave surface facing the object side.

The aperture stop S is disposed between the first focusing group GF1 and the second focusing group GF2 of the intermediate group Gi. In addition, an optical filter FL is disposed between the rear group Gr and an image plane I.

In the optical system OL8, at focusing on from an infinite distance object to a close distance object, the front group Gf and the rear group Gr are fixed relative to the image plane I, and the first focusing group GF and the second focusing group GF2 included in the intermediate group Gi move in the optical axis direction. Specifically, the first focusing group GF1 moves to the image plane side, and the second focusing group GF2 moves to the object side. At focusing, the aperture stop S is fixed relative to the image plane I.

Table 22 below shows values of specifications of the optical system OL8.

TABLE 22
Eighth example
[Overall specifications]

| | |
|---|---|
| f = | 50.155 |
| Fno = | 1.442 |
| ω = | 23.192 |
| Y = | 21.700 |
| TL = | 105.000 |
| TL (air-conversion length) = | 104.455 |
| Bf = | 12.000 |
| Bf (air-conversion length) = | 11.455 |

[Lens data]

| m | r | d | nd | νd | |
|---|---|---|---|---|---|
| Object surface | ∞ | D0 | | | |
| 1 | −2500.0000 | 2.1000 | 1.6727 | 32.18 | |
| 2 | 227.4741 | 5.4259 | | | |
| 3 | −47.7684 | 2.1000 | 1.6889 | 31.16 | |
| 4 | 77.1806 | 3.4485 | | | |
| 5 | 270.8996 | 6.8432 | 1.7725 | 49.62 | |
| 6 | −79.7306 | 0.4000 | | | |
| 7 | 67.5473 | 9.3010 | 1.7725 | 49.62 | |
| 8 | −93.3279 | 0.7000 | | | |
| 9 | 34.6119 | 6.2384 | 1.9027 | 35.77 | |
| 10 | 89.4449 | D10 | | | |
| 11 | 145.8308 | 1.5000 | 1.6727 | 32.18 | |
| 12 | 27.8700 | D12 | | | |
| 13 | ∞ | D13 | | | Aperture stop S |
| 14 | −23.6116 | 1.3188 | 1.8467 | 23.80 | |
| 15 | −140.1175 | 0.2000 | | | |
| 16 | 67.0940 | 7.4935 | 1.7725 | 49.62 | |
| 17 | −34.2758 | 3.1444 | | | |
| 18* | −138.8215 | 0.1500 | 1.5609 | 36.64 | |
| 19 | −136.6256 | 3.5903 | 1.8040 | 46.60 | |
| 20 | −46.1090 | D20 | | | |
| 21 | −47.9064 | 2.0000 | 1.5168 | 64.13 | |
| 22 | −1500.0000 | 10.3000 | | | |
| 23 | ∞ | 1.6000 | 1.5168 | 64.13 | |
| 24 | ∞ | 0.1000 | | | |
| Image plane | ∞ | | | | |

[Focal length of lens groups]

| Lens group | First surface | Focal length |
|---|---|---|
| Front group Gf | 1 | 30.362 |
| First focusing group GF1 | 11 | −51.482 |
| Second focusing group GF2 | 14 | 50.707 |
| Rear group Gr | 21 | −95.801 |

In the optical system OL8, the eighteenth surface is formed in an aspheric shape. Table 23 below shows aspheric surface data, in other words, the values of the conic constant K and the aspheric surface constants A4 to A10.

TABLE 23
[Aspheric surface data]

| m | K | A4 | A6 | A8 | A10 |
|---|---|---|---|---|---|
| 18 | 0.3300 | −1.68660E−05 | 3.23996E−09 | −6.68525E−11 | 7.39981E−14 |

In the optical system OL8, an on-axis air space D10 between the front group Gf and the first focusing group GF1, an on-axis air space D12 between the first focusing group GF1 and the aperture stop S, an on-axis air space D13 between the aperture stop S and the second focusing group GF2, and an on-axis air space D20 between the second focusing group GF2 and the rear group Gr change at focusing. Table 24 below shows variable spaces at focusing on an infinite distance object (infinite distance) and at focusing on a close distance object (close distance).

TABLE 24
[Variable space data]

| Focusing state | Infinite distance | Close distance |
|---|---|---|
| f | 50.155 | — |
| β | — | −0.162 |
| D0 | ∞ | 275.0000 |
| D10 | 3.0278 | 3.3513 |
| D12 | 7.8779 | 7.5545 |
| D13 | 15.7761 | 7.2312 |
| D20 | 10.3642 | 18.9092 |

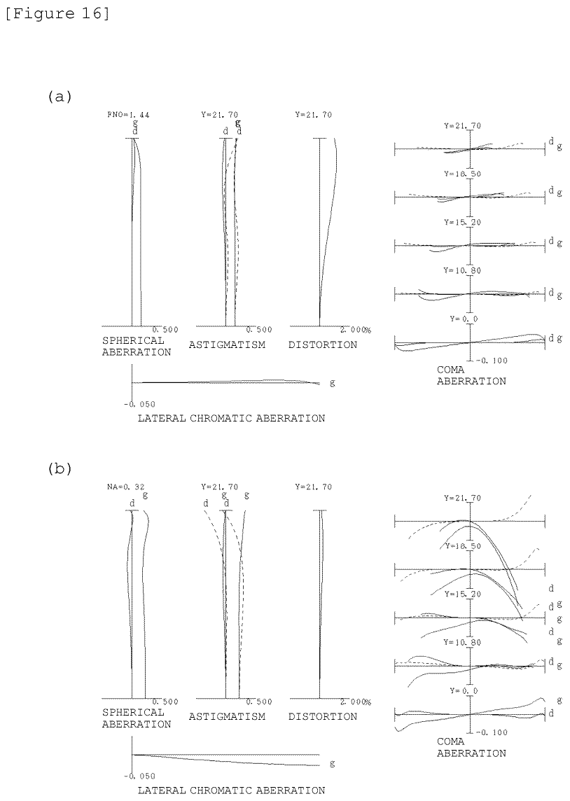

FIG. 16 shows a spherical aberration diagram, an astigmatism diagram, a distortion diagram, a lateral chromatic aberration diagram, and a coma aberration diagram of the optical system OL8 at focusing on an infinite distance object and at focusing on a close distance object. The aberration diagrams show that the optical system OL8 allows favorable correction of the variety of aberrations and has excellent imaging performance.

### Ninth Example

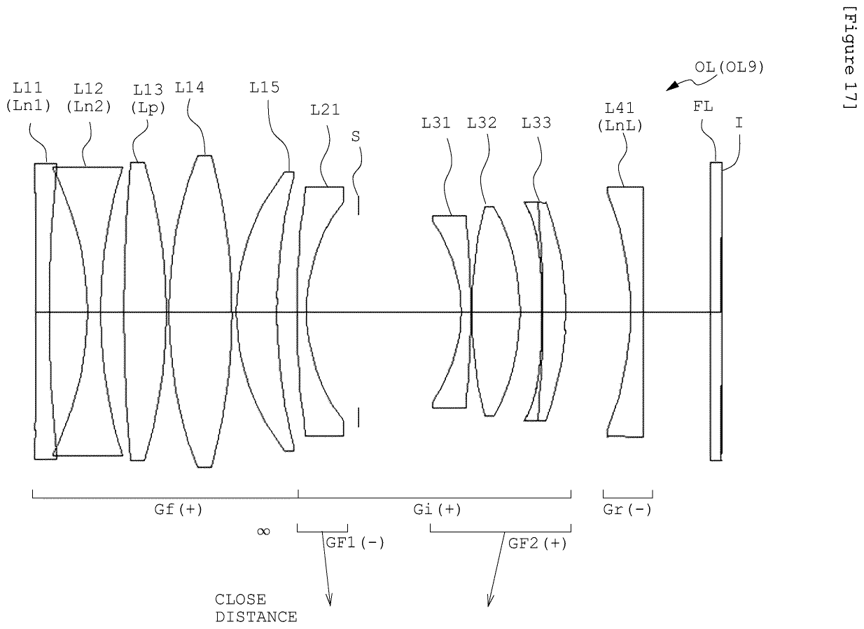

FIG. 17 shows the configuration of the optical system OL9 according to a ninth example. The optical system OL9 includes, sequentially from the object side, a front group Gf having positive refractive power, an intermediate group Gi having positive refractive power, and a rear group Gr having negative refractive power. The intermediate group Gi includes a first focusing group GF1 and a second focusing group GF2 that move along different loci, respectively, at focusing, the first focusing group GF1 having negative refractive power, the second focusing group GF2 having positive refractive power.

The front group Gf includes, sequentially from the object side, a biconcave negative lens L11 (negative lens component Ln1), a biconcave negative lens L12 (negative lens component Ln2), a biconvex positive lens L13 (positive lens component Lp), a biconvex positive lens L14, and a positive lens L15 in a meniscus shape having a convex surface facing the object side.

The first focusing group GF1 included in the intermediate group Gi includes a negative lens L21 in a meniscus shape having a convex surface facing the object side. The second focusing group GF2 included in the intermediate group Gi includes, sequentially from the object side, a negative lens L31 in a meniscus shape having a concave surface facing the object side, a biconvex positive lens L32, and a positive lens L33 in a meniscus shape formed with an aspheric lens surface on the object side and having a concave surface facing the object side. Note that the positive lens L33 is a composite lens having an aspheric surface formed of a resin layer provided on the object-side surface of a glass lens body.

The rear group Gr includes a negative lens L41 (negative lens component LnL) in a meniscus shape having a concave surface facing the object side.

The aperture stop S is disposed between the first focusing group GF1 and the second focusing group GF2 of the intermediate group Gi. In addition, an optical filter FL is disposed between the rear group Gr and an image plane I.

In the optical system OL9, at focusing on from an infinite distance object to a close distance object, the front group Gf and the rear group Gr are fixed relative to the image plane I, and the first focusing group GF and the second focusing group GF2 included in the intermediate group Gi move in the optical axis direction. Specifically, the first focusing group GF1 moves to the image plane side, and the second focusing group GF2 moves to the object side. At focusing, the aperture stop S is fixed relative to the image plane I.

Table 25 below shows values of specifications of the optical system OL9.

TABLE 25
Ninth example
[Overall specifications]

| | |
|---|---|
| f = | 50.207 |
| Fno = | 1.442 |
| ω = | 23.182 |
| Y = | 21.700 |
| TL = | 105.000 |
| TL (air-conversion length) = | 104.455 |
| Bf = | 12.000 |
| Bf (air-conversion length) = | 11.455 |

[Lens data]

| m | r | d | nd | νd | |
|---|---|---|---|---|---|
| Object surface | ∞ | D0 | | | |
| 1 | −2500.0000 | 2.1000 | 1.6727 | 32.18 | |
| 2 | 223.4413 | 5.8101 | | | |
| 3 | −47.5780 | 2.1000 | 1.6889 | 31.16 | |
| 4 | 76.9334 | 3.5168 | | | |
| 5 | 247.2706 | 6.4745 | 1.7725 | 49.62 | |
| 6 | −79.1295 | 0.4000 | | | |
| 7 | 67.9013 | 9.6242 | 1.7725 | 49.62 | |
| 8 | −93.1935 | 0.7000 | | | |
| 9 | 34.3436 | 6.1771 | 1.9027 | 35.77 | |
| 10 | 84.0877 | D10 | | | |
| 11 | 133.6598 | 1.5000 | 1.6727 | 32.18 | |
| 12 | 27.8700 | D12 | | | |
| 13 | ∞ | D13 | | | Aperture stop S |
| 14 | −23.9255 | 1.4374 | 1.8467 | 23.80 | |
| 15 | −145.2805 | 0.2000 | | | |
| 16 | 64.5899 | 7.3837 | 1.7725 | 49.62 | |
| 17 | −34.6828 | 3.3355 | | | |
| 18* | −129.1320 | 0.1500 | 1.5609 | 36.64 | |
| 19 | −168.1956 | 3.4884 | 1.8040 | 46.60 | |
| 20 | −47.1082 | D20 | | | |
| 21 | −47.4657 | 2.0000 | 1.5168 | 64.13 | |
| 22 | −1500.0000 | 10.3000 | | | |
| 23 | ∞ | 1.6000 | 1.5168 | 64.13 | |
| 24 | ∞ | 0.1000 | | | |
| Image plane | ∞ | | | | |

[Focal length of lens groups]

| Lens group | First surface | Focal length |
|---|---|---|
| Front group Gf | 1 | 30.697 |
| First focusing group GF1 | 11 | −52.645 |
| Second focusing group GF2 | 14 | 50.805 |
| Rear group Gr | 21 | −94.891 |

In the optical system OL9, the eighteenth surface is formed in an aspheric shape. Table 26 below shows aspheric surface data, in other words, the values of the conic constant K and the aspheric surface constants A4 to A10.

TABLE 26
[Aspheric surface data]

| m | K | A4 | A6 | A8 | A10 |
|---|---|---|---|---|---|
| 18 | 0.0638 | −1.74245E−05 | 5.05565E−09 | −8.05951E−11 | 1.01415E−13 |

In the optical system OL9, an on-axis air space D10 between the front group Gf and the first focusing group GF1, an on-axis air space D12 between the first focusing group GF1 and the aperture stop S, an on-axis air space D13 between the aperture stop S and the second focusing group GF2, and an on-axis air space D20 between the second focusing group GF2 and the rear group Gr change at focusing. Table 27 below shows variable spaces at focusing on an infinite distance object (infinite distance) and at focusing on a close distance object (close distance).

TABLE 27
[Variable space data]

| Focusing state | Infinite distance | Close distance |
|---|---|---|
| f | 50.207 | — |
| β | — | −0.162 |
| D0 | ∞ | 275.0000 |
| D10 | 3.0676 | 3.4313 |
| D12 | 7.9030 | 7.5394 |
| D13 | 15.7179 | 7.1851 |
| D20 | 9.9138 | 18.4466 |

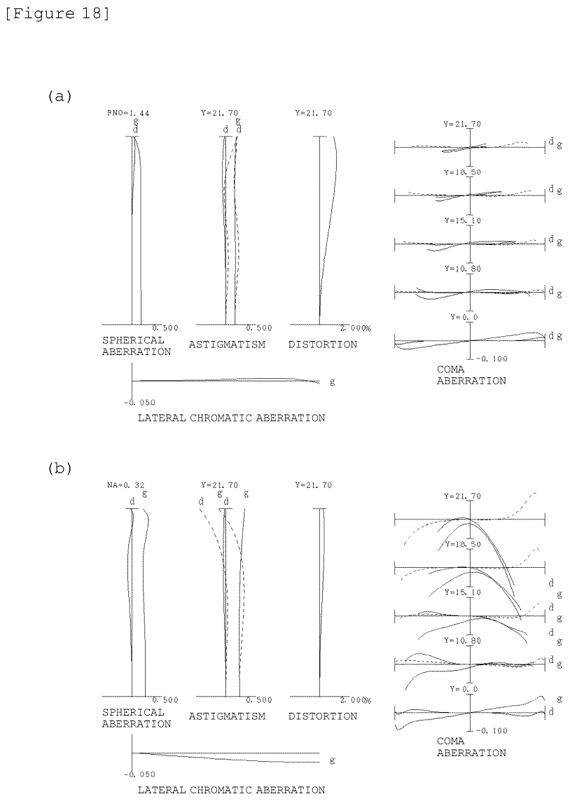

FIG. 18 shows a spherical aberration diagram, an astigmatism diagram, a distortion diagram, a lateral chromatic aberration diagram, and a coma aberration diagram of the optical system OL9 at focusing on an infinite distance object and at focusing on a close distance object. The aberration diagrams show that the optical system OL9 allows favorable correction of the variety of aberrations and has excellent imaging performance.

### Tenth Example

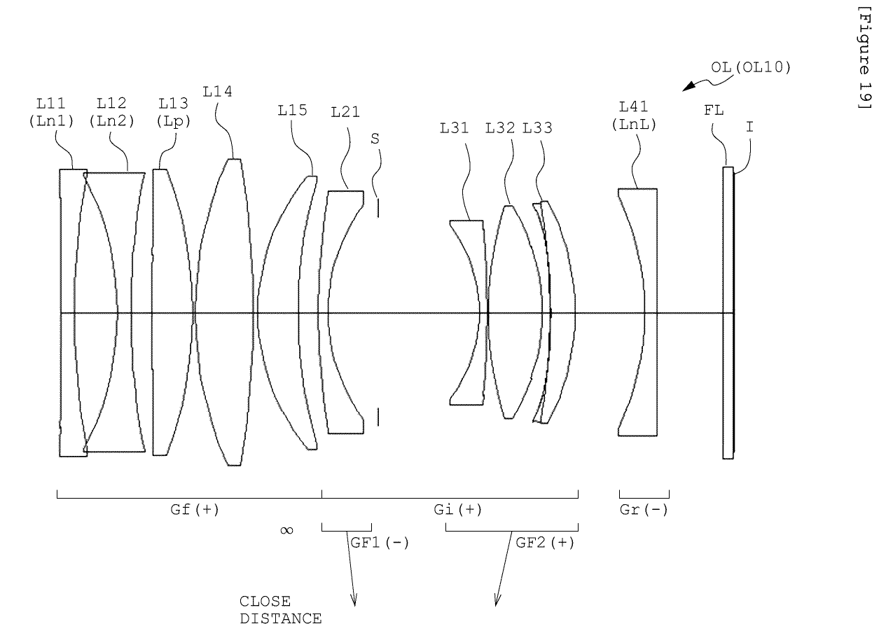

FIG. 19 shows the configuration of the optical system OL10 according to a tenth example. The optical system OL10 includes, sequentially from the object side, a front group Gf having positive refractive power, an intermediate group Gi having positive refractive power, and a rear group Gr having negative refractive power. The intermediate group Gi includes a first focusing group GF1 and a second focusing group GF2 that move along different loci, respectively, at focusing, the first focusing group GF1 having negative refractive power, the second focusing group GF2 having positive refractive power.

The front group Gf includes, sequentially from the object side, a biconcave negative lens L11 (negative lens component Ln1), a biconcave negative lens L12 (negative lens component Ln2), a biconvex positive lens L13 (positive lens component Lp), a biconvex positive lens L14, and a positive lens L15 in a meniscus shape having a convex surface facing the object side.

The first focusing group GF1 included in the intermediate group Gi includes a negative lens L21 in a meniscus shape having a convex surface facing the object side. The second focusing group GF2 included in the intermediate group Gi includes, sequentially from the object side, a negative lens L31 in a meniscus shape having a concave surface facing the object side, a biconvex positive lens L32, and a positive lens L33 in a meniscus shape formed with an aspheric lens surface on the object side and having a concave surface facing the object side. Note that the positive lens L33 is a composite lens having an aspheric surface formed of a resin layer provided on the object-side surface of a glass lens body.

The rear group Gr includes a negative lens L41 (negative lens component LnL) in a meniscus shape having a concave surface facing the object side.

The aperture stop S is disposed between the first focusing group GF1 and the second focusing group GF2 of the intermediate group Gi. In addition, an optical filter FL is disposed between the rear group Gr and an image plane I.

In the optical system OL10, at focusing on from an infinite distance object to a close distance object, the front group Gf and the rear group Gr are fixed relative to the image plane I, and the first focusing group GF and the second focusing group GF2 included in the intermediate group Gi move in the optical axis direction. Specifically, the first focusing group GF1 moves to the image plane side, and the second focusing group GF2 moves to the object side. At focusing, the aperture stop S is fixed relative to the image plane I.

Table 28 below shows values of specifications of the optical system OL10.

TABLE 28
Tenth example
[Overall specifications]

| | |
|---|---|
| f = | 50.183 |
| Fno = | 1.442 |
| ω = | 22.997 |
| Y = | 21.700 |
| TL = | 105.000 |
| TL (air-conversion length) = | 104.455 |
| Bf = | 12.000 |
| Bf (air-conversion length) = | 11.455 |

[Lens data]

| m | r | d | nd | νd | |
|---|---|---|---|---|---|
| Object surface | ∞ | D0 | | | |
| 1 | −2500.0000 | 2.1000 | 1.6990 | 30.13 | |
| 2 | 115.3990 | 6.7334 | | | |
| 3 | −46.5667 | 2.1000 | 1.6477 | 33.72 | |
| 4 | 111.8707 | 3.3473 | | | |
| 5 | 2352.1374 | 6.3014 | 1.8040 | 46.60 | |
| 6 | −63.0433 | 0.4000 | | | |
| 7 | 59.2892 | 9.0580 | 1.7725 | 49.62 | |
| 8 | −141.0712 | 0.7000 | | | |
| 9 | 32.8679 | 6.2958 | 1.9027 | 35.77 | |
| 10 | 75.0665 | D10 | | | |
| 11 | 111.2091 | 1.5000 | 1.7618 | 26.58 | |
| 12 | 28.1650 | D12 | | | |
| 13 | ∞ | D13 | | | Aperture stop S |
| 14 | −22.2922 | 1.2000 | 1.7283 | 28.38 | |
| 15 | −151.3964 | 0.2000 | | | |
| 16 | 57.3660 | 8.4208 | 1.6968 | 55.52 | |
| 17 | −31.6166 | 1.1458 | | | |
| 18* | −152.6794 | 0.1500 | 1.5609 | 36.64 | |
| 19 | −91.9729 | 3.8171 | 1.5168 | 64.13 | |
| 20 | −37.8318 | D20 | | | |
| 21 | −42.7284 | 2.0000 | 1.5168 | 64.13 | |
| 22 | −1500.0000 | 10.3000 | | | |
| 23 | ∞ | 1.6000 | 1.5168 | 64.13 | |
| 24 | ∞ | 0.1000 | | | |
| Image plane | ∞ | | | | |

[Focal length of lens groups]

| Lens group | First surface | Focal length |
|---|---|---|
| Front group Gf | 1 | 30.209 |
| First focusing group GF1 | 11 | −49.899 |
| Second focusing group GF2 | 14 | 49.218 |
| Rear group Gr | 21 | −85.143 |

In the optical system OL10, the eighteenth surface is formed in an aspheric shape. Table 29 below shows aspheric surface data, in other words, the values of the conic constant K and the aspheric surface constants A4 to A10.

TABLE 29
[Aspheric surface data]

| m | K | A4 | A6 | A8 | A10 |
|---|---|---|---|---|---|
| 18 | 0.7312 | −1.79104E−05 | −2.42997E−09 | −5.25233E−11 | 4.81955E−14 |

In the optical system OL10, an on-axis air space D10 between the front group Gf and the first focusing group GF1, an on-axis air space D12 between the first focusing group GF1 and the aperture stop S, an on-axis air space D13 between the aperture stop S and the second focusing group GF2, and an on-axis air space D20 between the second focusing group GF2 and the rear group Gr change at focusing. Table 30 below shows variable spaces at focusing on an infinite distance object (infinite distance) and at focusing on a close distance object (close distance).

TABLE 30
[Variable space data]

| Focusing state | Infinite distance | Close distance |
|---|---|---|
| f | 50.183 | — |
| β | — | −0.162 |
| D0 | ∞ | 275.0000 |
| D10 | 3.1064 | 3.2365 |
| D12 | 7.8363 | 7.7062 |
| D13 | 15.7794 | 7.3854 |
| D20 | 10.8083 | 19.2024 |

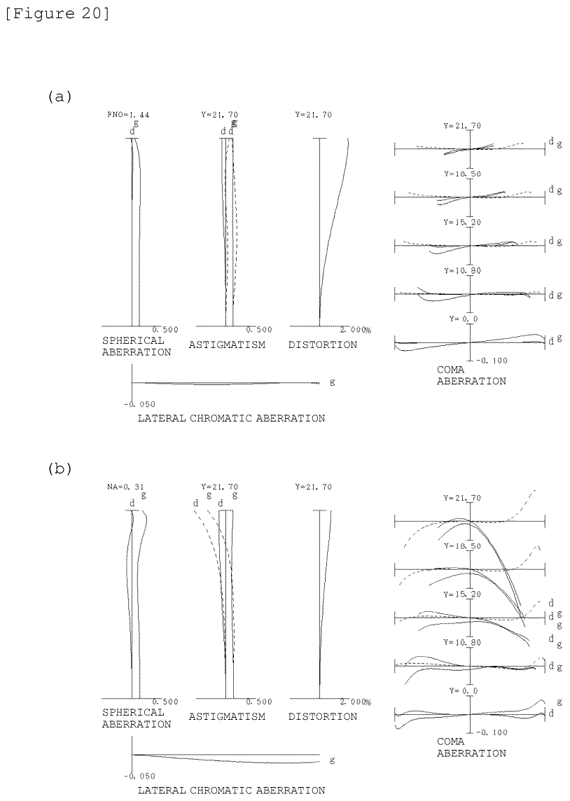

FIG. 20 shows a spherical aberration diagram, an astigmatism diagram, a distortion diagram, a lateral chromatic aberration diagram, and a coma aberration diagram of the optical system OL10 at focusing on an infinite distance object and at focusing on a close distance object. The aberration diagrams show that the optical system OL10 allows favorable correction of the variety of aberrations and has excellent imaging performance.

### Eleventh Example

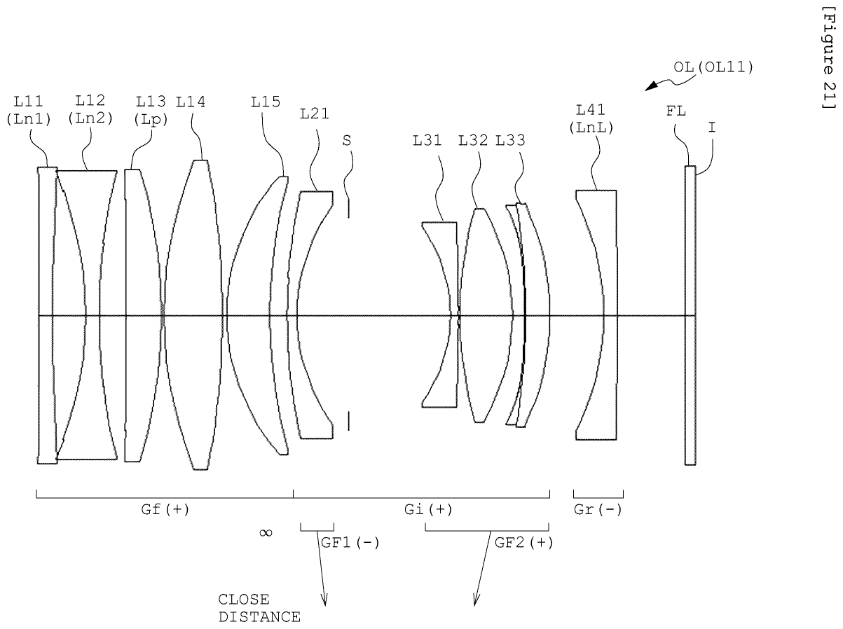

FIG. 21 shows the configuration of the optical system OL11 according to an eleventh example. The optical system OL11 includes, sequentially from the object side, a front group Gf having positive refractive power, an intermediate group Gi having positive refractive power, and a rear group Gr having negative refractive power. The intermediate group Gi includes a first focusing group GF1 and a second focusing group GF2 that move along different loci, respectively, at focusing, the first focusing group GF1 having negative refractive power, the second focusing group GF2 having positive refractive power.

The front group Gf includes, sequentially from the object side, a biconcave negative lens L11 (negative lens component Ln1), a biconcave negative lens L12 (negative lens component Ln2), a positive lens L13 (positive lens component Lp) in a meniscus shape having a concave surface facing the object side, a biconvex positive lens L14, and a positive lens L15 in a meniscus shape having a convex surface facing the object side.

The first focusing group GF1 included in the intermediate group Gi includes a negative lens L21 in a meniscus shape having a convex surface facing the object side. The second focusing group GF2 included in the intermediate group Gi includes, sequentially from the object side, a negative lens L31 in a meniscus shape having a concave surface facing the object side, a biconvex positive lens L32, and a positive lens L33 in a meniscus shape formed with an aspheric lens surface on the object side and having a concave surface facing the object side. Note that the positive lens L33 is a composite lens having an aspheric surface formed of a resin layer provided on the object-side surface of a glass lens body.

The rear group Gr includes a negative lens L41 (negative lens component LnL) in a meniscus shape having a concave surface facing the object side.

The aperture stop S is disposed between the first focusing group GF1 and the second focusing group GF2 of the intermediate group Gi. In addition, an optical filter FL is disposed between the rear group Gr and an image plane I.

In the optical system OL11, at focusing on from an infinite distance object to a close distance object, the front group Gf and the rear group Gr are fixed relative to the image plane I, and the first focusing group GF and the second focusing group GF2 included in the intermediate group Gi move in the optical axis direction. Specifically, the first focusing group GF1 moves to the image plane side, and the second focusing group GF2 moves to the object side. At focusing, the aperture stop S is fixed relative to the image plane I.

Table 31 below shows values of specifications of the optical system OL11.

TABLE 31
Eleventh example
[Overall specifications]

| | |
|---|---|
| f = | 51.600 |
| Fno = | 1.442 |
| ω = | 22.108 |
| Y = | 21.700 |
| TL = | 100.000 |
| TL (air-conversion length) = | 99.455 |
| Bf = | 12.000 |
| Bf (air-conversion length) = | 11.455 |

[Lens data]

| m | r | d | nd | νd | |
|---|---|---|---|---|---|
| Object surface | ∞ | D0 | | | |
| 1 | −2200.0000 | 2.1000 | 1.7847 | 25.64 | |
| 2 | 342.3765 | 4.9940 | | | |
| 3 | −54.9483 | 2.1000 | 1.6727 | 32.18 | |
| 4 | 90.7729 | 4.1496 | | | |
| 5 | −930.1950 | 5.2945 | 1.8040 | 46.60 | |
| 6 | −75.6292 | 0.4000 | | | |
| 7 | 62.3281 | 8.8945 | 1.7725 | 49.62 | |
| 8 | −123.5225 | 0.7000 | | | |
| 9 | 32.0940 | 6.5380 | 1.9027 | 35.77 | |
| 10 | 78.0753 | D10 | | | |
| 11 | 89.5340 | 1.5000 | 1.8052 | 25.45 | |
| 12 | 28.4800 | D12 | | | |
| 13 | ∞ | D13 | | | Aperture stop S |
| 14 | −22.9197 | 1.2000 | 1.7283 | 28.38 | |
| 15 | −319.9378 | 0.2000 | | | |
| 16 | 56.9374 | 8.0362 | 1.7725 | 49.62 | |
| 17 | −32.6391 | 1.8136 | | | |
| 18* | −127.8407 | 0.1500 | 1.5609 | 36.64 | |
| 19 | −106.4043 | 3.6973 | 1.5168 | 64.13 | |
| 20 | −40.1307 | D20 | | | |
| 21 | −38.5377 | 2.0000 | 1.5174 | 52.20 | |
| 22 | −1500.0000 | 10.3000 | | | |
| 23 | ∞ | 1.6000 | 1.5168 | 64.13 | |
| 24 | ∞ | 0.1000 | | | |
| Image plane | ∞ | | | | |

[Focal length of lens group]

| Lens group | First surface | Focal length |
|---|---|---|
| Front group Gf | 1 | 30.777 |
| First focusing group GF1 | 11 | −52.445 |
| Second focusing group GF2 | 14 | 50.251 |
| Rear group Gr | 21 | −76.480 |

In the optical system OL11, the eighteenth surface is formed in an aspheric shape. Table 32 below shows aspheric surface data, in other words, the values of the conic constant K and the aspheric surface constants A4 to A10.

TABLE 32
[Aspheric surface data]

| m | K | A4 | A6 | A8 | A10 |
|---|---|---|---|---|---|
| 18 | 1.3832 | −1.99019E−05 | −2.27842E−09 | −7.46867E−11 | 9.72348E−14 |

In the optical system OL11, an on-axis air space D10 between the front group Gf and the first focusing group GF1, an on-axis air space D12 between the first focusing group GF1 and the aperture stop S, an on-axis air space D13 between the aperture stop S and the second focusing group GF2, and an on-axis air space D20 between the second focusing group GF2 and the rear group Gr change at focusing. Table 33 below shows variable spaces at focusing on an infinite distance object (infinite distance) and at focusing on a close distance object (close distance).

TABLE 33
[Variable space data]

| Focusing state | Infinite distance | Close distance |
|---|---|---|
| f | 51.600 | — |
| β | — | −0.164 |
| D0 | ∞ | 279.9120 |
| D10 | 2.6387 | 3.1745 |
| D12 | 7.8303 | 7.2947 |
| D13 | 15.5118 | 7.1238 |
| D20 | 8.2515 | 16.6395 |

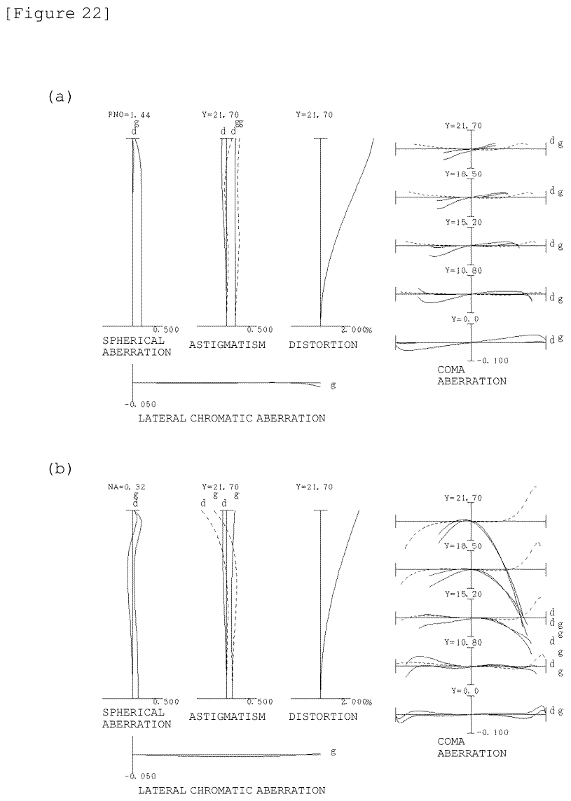

FIG. 22 shows a spherical aberration diagram, an astigmatism diagram, a distortion diagram, a lateral chromatic aberration diagram, and a coma aberration diagram of the optical system OL11 at focusing on an infinite distance object and at focusing on a close distance object. The aberration diagrams show that the optical system OL11 allows favorable correction of the variety of aberrations and has excellent imaging performance.

### [Conditional Expression Correspondence Value]

Table 34 below shows correspondence values of Conditional Expressions (1) to (11) in the first to eleventh examples.

TABLE 34

| | |
|---|---|
| (1) | \|fF1\|/(−fr) |
| (2) | \|fF2\|/ff |
| (3) | ff/(−fr) |
| (4) | (r2 + r1)/(r2 − r1) |
| (5) | \|fF2\|/\|fF1\| |
| (6) | ff/\|fF1\| |
| (7) | (−fr)/\|fF2\| |
| (8) | fsr/fsf |
| (9) | y/Bfa |
| (10) | f/Bfa |
| (11) | TLa/f |

| | First | Second | Third | Fourth |
|---|---|---|---|---|
| | example | example | example | example |
| fsf | 49.043 | 47.148 | 49.015 | 52.793 |
| fsr | 77.772 | 92.191 | 82.478 | 70.288 |
| (1) | 0.813 | 1.407 | 1.063 | 0.879 |
| (2) | 1.560 | 1.370 | 1.482 | 1.427 |
| (3) | 0.329 | 0.464 | 0.348 | 0.319 |
| (4) | 0.062 | 0.084 | −0.001 | −0.067 |
| (5) | 0.632 | 0.452 | 0.485 | 0.517 |
| (6) | 0.405 | 0.330 | 0.327 | 0.363 |
| (7) | 1.948 | 1.572 | 1.940 | 2.198 |
| (8) | 1.586 | 1.955 | 1.683 | 1.331 |
| (9) | 1.894 | 2.018 | 2.018 | 2.018 |
| (10) | 3.117 | 3.254 | 3.255 | 3.254 |
| (11) | 2.926 | 2.842 | 2.841 | 2.842 |
| | Fifth | Sixth | Seventh | Eighth |
| | example | example | example | example |
| fsf | 48.190 | 47.746 | 66.728 | 67.458 |
| fsr | 94.490 | 96.813 | 119.770 | 94.796 |
| (1) | 2.354 | 2.469 | 1.570 | 0.537 |
| (2) | 1.190 | 1.193 | 1.189 | 1.670 |
| (3) | 0.549 | 0.555 | 0.547 | 0.317 |
| (4) | −0.004 | −0.024 | 0.139 | −0.653 |
| (5) | 0.277 | 0.268 | 0.414 | 0.985 |
| (6) | 0.233 | 0.225 | 0.348 | 0.590 |
| (7) | 1.532 | 1.510 | 1.538 | 1.889 |
| (8) | 1.961 | 2.028 | 1.795 | 1.405 |
| (9) | 2.018 | 2.018 | 1.894 | 1.894 |
| (10) | 3.254 | 3.254 | 4.365 | 4.379 |
| (11) | 2.842 | 2.842 | 2.089 | 2.083 |

| | Ninth | Tenth | Eleventh |
|---|---|---|---|
| | example | example | example |
| fsf | 67.037 | 68.804 | 64.836 |
| fsr | 96.271 | 97.902 | 122.966 |
| (1) | 0.555 | 0.586 | 0.686 |
| (2) | 1.655 | 1.629 | 1.633 |
| (3) | 0.323 | 0.355 | 0.402 |
| (4) | −0.649 | −0.425 | −0.723 |
| (5) | 0.965 | 0.986 | 0.958 |
| (6) | 0.583 | 0.605 | 0.587 |
| (7) | 1.868 | 1.730 | 1.522 |
| (8) | 1.436 | 1.423 | 1.897 |
| (9) | 1.894 | 1.894 | 1.894 |
| (10) | 4.383 | 4.381 | 4.505 |
| (11) | 2.080 | 2.081 | 1.927 |

Reference Signs List

| | |
|---|---|
| 1 | camera (optical apparatus) |
| OL (OL1 to OL11) | optical system |
| Gf | front group |
| Gi | intermediate group |
| GF1 | first focusing group |
| GF2 | second focusing group |
| Gr | rear group |
| Ln1 | negative lens component |
| Ln2 | negative lens component |
| Lp | positive lens component |
| LnL | negative lens component |

1. An optical system comprising, in order from an object side, a front group having positive refractive power, an intermediate group, and a rear group having negative refractive power, wherein
the intermediate group includes a first focusing group and a second focusing group that move along different loci, respectively, at focusing,
the front group includes, in order from the object side, a negative lens component, a negative lens component, and a positive lens component,
the rear group includes a negative lens component closest to an image plane side, and
the following conditional expressions are satisfied:
$$0.10 < \vert fF 1 \vert / ( - fr ) < 2.6$$
$$0.7 < \vert fF 2 \vert / ff < 2.$$
where
fF1: focal length of the first focusing group,
fr: focal length of the rear group,
fF2: focal length of the second focusing group, and
ff: focal length of the front group.

2. An optical system comprising, in order from an object side, a front group having positive refractive power, an intermediate group, and a rear group having negative refractive power, wherein
the intermediate group includes a first focusing group and a second focusing group that move along different loci, respectively, at focusing,
the front group includes, in order from the object side, a negative lens component, a negative lens component, and a positive lens component,
the rear group includes a negative lens component closest to an image plane side, and
the following conditional expressions are satisfied:
$$0.05 < ff / ( - fr ) < 0 \text{.90}$$
$$- 1. < ( r 2 + r 1 ) / ( r 2 - r 1 ) < 0.2$$
where
ff: focal length of the front group,
fr: focal length of the rear group,
r1: radius of curvature of a lens surface of a lens component disposed closest to the object side, the lens surface being on the image plane side, and
r2: radius of curvature of a lens surface of a lens component disposed second closest to the object side, the lens surface being on the object side.

3. The optical system according to claim 1, wherein the following conditional expression is satisfied:
$$0. 10 < ff / ( - fr ) < 0.9$$

4. The optical system according to claim 1, wherein the following conditional expression is satisfied:
$$- 1.0 \; 00 < ( r 2 + r 1 ) / ( r 2 - r 1 ) < 0.2$$
where
r1: radius of curvature of a lens surface of a lens component disposed closest to the object side, the lens surface being on the image plane side, and
r2: radius of curvature of a lens surface of a lens component disposed second closest to the object side, the lens surface being on the object side.

5. The optical system according to claim 1, wherein the following conditional expression is satisfied:
$$0.10 < \vert fF 2 \vert / \vert fF 1 \vert < 1.1$$

6. The optical system according to claim 1, wherein the following conditional expression is satisfied:
$$0.10 < ff / \vert fF 1 \vert < 0.65$$

7. The optical system according to claim 1, wherein the following conditional expression is satisfied:
$$1.1 < ( - fr ) / \vert fF 2 \vert < 2.4$$

8. The optical system according to claim 1, further comprising an aperture between the first focusing group and the second focusing group, and wherein the following conditional expression is satisfied:
$$1. < fsr / fsf < 2.20$$
where
fsr: combined focal length of lenses disposed on the image plane side of the aperture at focusing on an infinite distance object, and
fsf: combined focal length of lenses disposed on the object side of the aperture at focusing on an infinite distance object.

9. The optical system according to claim 1, wherein the following conditional expression is satisfied;
$$0.8 < y / Bfa < 2.10$$
where
y: image height of the optical system, and
Bfa: back focus (air-conversion length) of the optical system at focusing on an infinite distance object.

10. The optical system according to claim 1, wherein the following conditional expression is satisfied:
$$1.5 < y / Bfa < 5.$$
where
f: overall focal length of the optical system at focusing on an infinite distance object, and
Bfa: back focus (air-conversion length) of the optical system at focusing on an infinite distance object.

11. The optical system according to claim 1, wherein the following conditional expression is satisfied:
$$1.5 < TLa / f < 3. 50$$
where
f: overall focal length of the optical system at focusing on an infinite distance object, and
TLa: optical total length (air-conversion length) of the optical system at focusing on an infinite distance object.

12. The optical system according to claim 1, wherein the first focusing group has negative refractive power.

13. The optical system according to claim 1, wherein the second focusing group has positive refractive power.

14. An optical apparatus comprising the optical system according to claim 1.

15. A method for manufacturing an optical system including, in order from an object side, a front group having positive refractive power, an intermediate group, and a rear group having negative refractive power, the method comprising:
configuring the intermediate group to include a first focusing group and a second focusing group that move along different loci, respectively, at focusing;
configuring the front group to include, in order from the object side, a negative lens component, a negative lens component, and a positive lens component; and
configuring the rear group to include a negative lens component closest to an image plane side,
the method further comprising one of the following features A or B:
the feature A comprising:
satisfying the following conditional expressions:
$$0.10 < \vert fF 1 \vert / ( - fr ) < 2.6$$
$$0.7 < \vert fF 2 \vert / ff < 2.$$
where
fF1: focal length of the first focusing group,
fr: focal length of the rear group,
fF2: focal length of the second focusing group, and
ff: focal length of the front group,
the feature B comprising:
satisfying the following conditional expressions:
$$0.05 < ff / ( - fr ) < 0.9$$
$$- 1. < ( r 2 + r 1 ) / ( r 2 - r 1 ) < 0.2$$
where
ff: focal length of the front group,
fr: focal length of the rear group,
r1: radius of curvature of a lens surface of a lens component disposed closest to the object side, the lens surface being on the image plane side, and
r2: radius of curvature of a lens surface of a lens component disposed second closest to the object side, the lens surface being on the object side.

16. (canceled)

17. The optical system according to claim 2, wherein the following conditional expression is satisfied:
$$0.10 < \vert fF 2 \vert / \vert fF 1 \vert < 1.1$$
where
fF1: focal length of the first focusing group, and
fF2: focal length of the second focusing group.

18. The optical system according to claim 2, wherein the following conditional expression is satisfied:
$$0.10 < ff / \vert fF 1 \vert < 0.65$$
where
fF1: focal length of the first focusing group.

19. The optical system according to claim 2, wherein the following conditional expression is satisfied:
$$1.1 < ( - fr ) / \vert fF 2 \vert < 2.40$$
where
fF2: focal length of the second focusing group.

20. The optical system according to claim 2, further comprising an aperture between the first focusing group and the second focusing group,
wherein the following conditional expression is satisfied:
$$1. < fsr / fsf < 2.20$$
where
fsr: combined focal length of lenses disposed on the image plane side of the aperture at focusing on an infinite distance object, and
fsf: combined focal length of lenses disposed on the object side of the aperture at focusing on an infinite distance object.

21. An optical apparatus comprising the optical system according to claim 2.
